(19) United States
(12) Patent Application Publication
(10) Pub. No.: US 2024/0298263 A1
(43) Pub. Date: Sep. 5, 2024

(54) ADAPTIVE BEAM SKIPPING OF SYNCHRONIZATION SIGNAL BLOCK TRANSMISSION

(71) Applicant: Dell Products, L.P., Round Rock, TX (US)

(72) Inventor: Ali Esswie, Calgary (CA)

(21) Appl. No.: 18/176,491

(22) Filed: Mar. 1, 2023

(51) Int. Cl. H04W 52/02; H04B 17/318; H04W 56/00

(52) U.S. Cl. CPC H04W 52/0232; H04B 17/318; H04W 56/0015

(57) ABSTRACT

A radio access network node transmits a beam skipping configuration comprising beam skipping sequences to user equipment. The node may implement one or more of the beam skipping sequences based on a number of user equipment attempting to connect with the node. The node may transmit a beam skipping sequence indication in a synchronization signal block signal. A user equipment may receive the beam skipping sequence indication and attempt to connect with the node according to the beam skipping sequence corresponding to the beam skipping indication. The user equipment may determine signal strengths of non-skipped beams of the beam-skipping sequence and transmit a random-access code via a first or second configured random-access occasion corresponding to a strongest of the non-skipped beams. The node may determine to change the beam skipping sequence or to connect with the user equipment based on the random-access occasion used to transmit the random-access code.

### BACKGROUND

The ‘New Radio’ (NR) terminology that is associated with fifth generation mobile wireless communication systems (“5G”) refers to technical aspects used in wireless radio access networks (“RAN”) that comprise several quality of service classes (QoS), including ultrareliable and low latency communications (“URLLC”), enhanced mobile broadband (“eMBB”), and massive machine type communication (“mMTC”). The URLLC QoS class is associated with a stringent latency requirement (e.g., low latency or low signal/message delay) and a high reliability of radio performance, while conventional eMBB use cases may be associated with high-capacity wireless communications, which may permit less stringent latency requirements (e.g., higher latency than URLLC) and less reliable radio performance as compared to URLLC. Performance requirements for mMTC may be lower than for eMBB use cases. Some use case applications involving mobile devices or mobile user equipment such as smart phones, wireless tablets, smart watches, and the like, may impose on a given RAN resource loads, or demands, that vary. A RAN node may activate a network energy saving mode to reduce power consumption.

### SUMMARY

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

In an example embodiment, a method may comprise exiting, by a user equipment comprising a processor, a sleep state according to a configured first beam skipping sequence. The user equipment may determine to exit the sleep state as part of a process of transition from an idle mode to a connected mode vis-à-vis a radio access network node. The method may comprise decoding, by the user equipment, a first synchronization signal block signal corresponding to at least one active beam indicated by the configured first beam skipping sequence as being a non-skipped beam and transmitting, by the user equipment, a random-access code via a random-access occasion corresponding to the at least one active beam indicated by the configured first beam skipping sequence as being a non-skipped beam. The method may further comprise entering the sleep state according to the configured first beam skipping sequence.

In an embodiment, the method may comprise decoding, by the user equipment, a second synchronization signal block signal, wherein the second synchronization signal block signal comprises a beam skipping sequence indication indicative of the configured first beam skipping sequence. The second synchronization signal block signal may be received by the user equipment before the first synchronization signal block signal. The beam skipping sequence indication may comprise an active time indication indicative of an active period of the configured first beam skipping sequence. The beam skipping sequence indication may comprise a random-access occasion indication indicative of more than one random-access occasion being associated by the configured first beam skipping sequence with at least one non-skipped beam. In an embodiment, at least one non-skipped beam associated with the more than one random-access occasion may be geospatially adjacent to at least one skipped beam indicated by the configured first beam skipping sequence as being a skipped beam. A random-access occasion associated by the configured first beam skipping sequence with at least one non-skipped beam may be configured as a primary random-access occasion that the user equipment may use to transmit a random-access code to indicate to a radio access network node that a beam signal strength of the at least one non-skipped beam satisfies a coverage criterion, or threshold, at the user equipment. A random-access occasion associated by the configured first beam skipping sequence with at least one non-skipped beam may be configured as a secondary random-access occasion that the user equipment may use to transmit a random access code to indicate to a radio access network node that a beam signal strength of the at least one non-skipped beam does not satisfy a coverage criterion, or threshold, at the user equipment, and that the user equipment may be better served by a beam geospatially adjacent to the at least one non-skipped beam.

The example method may comprise receiving, by the user equipment from a radio access network node, a beam skipping configuration comprising the configured first beam skipping sequence. The example method may comprise decoding, by the user equipment, a second synchronization signal block signal, wherein the second synchronization signal block signal comprises a beam skipping sequence indication indicative of the configured first beam skipping sequence. The example method may comprise scheduling the exiting of the sleep state based on the beam skipping sequence indication being indicative of the configured first beam skipping sequence.

In an embodiment, the example method may comprise determining, by the user equipment, at least one signal strength corresponding to the at least one active (e.g., non-skipped) beam indicated by the configured first beam skipping sequence as being a non-skipped beam to result in a determined at least one signal strength. The method may comprise analyzing, by the user equipment, the determined at least one signal strength with respect to a beam selection criterion to result in an analyzed determined signal strength, wherein the transmitting of the random-access code is based on the analyzed determined signal strength satisfying a beam selection criterion. The beam selection criterion may comprise a determined signal strength-threshold, or a configured signal strength threshold. The beam selection criterion may be a criterion such that satisfaction by an analyzed determined signal strength is indicative of the at least one active, non-skipped beam, having a signal strength that can provide a performance level of communication between the user equipment and a radio access network node that satisfies a performance criterion, such as, for example, a quality of service, a latency target, a processor performance target, or an energy usage target (at the user equipment or at the radio access node), or other performance metric.

In an embodiment, the beam selection criterion may be a first beam selection criterion, wherein the random-access occasion is a first random-access occasion, and wherein the first beam selection criterion is satisfied by the analyzed determined signal strength being higher than signal strengths corresponding to other of the at least one active beam indicated by the configured first beam skipping sequence as being a non-skipped beam.

In an embodiment, the beam selection criterion may be a second beam selection criterion, wherein the random-access occasion is a second random-access occasion, and wherein the second beam selection criterion is satisfied by the analyzed determined signal strength being lower than a configured signal strength threshold. The at least one active beam may be geospatially adjacent to at least one skipped beam indicated by the configured first beam skipping sequence as being a skipped beam, and the transmitting of the random-access code via the second random-access occasion may indicate to a radio access network node receiving the random-access code to select a configured second beam skipping sequence that does not indicate as a skipped beam the at least one skipped beam that is geospatially adjacent to the at least one active beam. Thus, receiving, by a radio access network node a random-access code via a secondary random-access occasion my trigger a beam-skipping refinement, or merely beam refinement, process that changes transmission of SSB signals according to the first beam skipping sequence to the transmission of SSB signals according to the second beam skipping sequence, or according to a third, fourth, and so on for other beam skipping sequences.

In another embodiment, a user equipment comprises a processor to receive, from a radio access network node, a beam skipping sequence indication indicative of a beam skipping sequence of a beam skipping configuration. The processor may be configured to monitor at least one synchronization signal corresponding to the radio access network node according to the beam skipping sequence, and to transmit, to the radio access network node, a random-access code via a random-access resource (e.g., a time or frequency resource) corresponding to a beam indicated by the beam skipping sequence as being a non-skipped beam. The at least one synchronization signal may comprise a random-access transmission indication indicative of more than one random-access resource being associated with at least one non-skipped beam corresponding to the beam skipping sequence.

The processor of the user equipment may be further configured to determine at least one signal strength corresponding to the beam indicated by the beam skipping sequence as being a non-skipped beam to result in a determined signal strength. The processor may be configured to analyze the determined signal strength with respect to a beam selection criterion to result in an analyzed determined signal strength and to transmit the random-access code based on the analyzed determined signal strength satisfying a beam selection criterion. The beam selection criterion may be a first beam selection criterion, the random-access resource may be a first random-access resource, which may correspond to a primary random-access occasion in the beam skipping configuration, and the first beam selection criterion may be satisfied by the analyzed determined signal strength being higher than signal strengths corresponding to other beams that are indicated by the beam skipping sequence as being non-skipped beams. The beam selection criterion may be a second beam selection criterion, the random-access resource may be a second random-access resource, which may correspond to a secondary random-access occasion in the beam skipping configuration, and the second beam selection criterion may be satisfied by the analyzed determined signal strength being higher than signal strengths corresponding to other beams that are indicated by the beam skipping sequence as being non-skipped beams and by the analyzed determined signal strength being lower than a configured signal strength threshold.

In another example embodiment, a non-transitory machine-readable medium comprises executable instructions that, when executed by a processor of a user equipment, facilitate performance of operations, comprising receiving, from a radio access network node, a beam skipping configuration comprising at least one beam skipping sequence and receiving, from the radio access network node, a first synchronization signal block signal comprising a beam skipping sequence indication indicative of the at least one beam skipping sequence. The operations may further comprise, decoding, based on the beam skipping sequence indication being indicative of the at least one beam skipping sequence, a second synchronization signal block signal corresponding to a beam indicated by the at least one beam skipping sequence as being a non-skipped beam. The operations may further comprise transmitting, to the radio access network node, a random-access preamble via a random-access occasion corresponding to the beam indicated by the at least one beam skipping sequence indication as being a non-skipped beam. The beam skipping sequence indication may comprise a random-access occasion indication indicative of more than one random-access occasion being associated with at least one non-skipped beam of the at least one beam skipping sequence.

In an embodiment, at least one non-skipped beam, of the at least one beam skipping sequence, associated with the more than one random-access occasion may be geospatially adjacent to at least one skipped beam indicated by the at least one beam skipping sequence as being a skipped beam. This embodiment may facilitate the user equipment indicating to the radio access network node that the user equipment may be better served by the geospatially adjacent skipped beam instead of by the non-skipped beam. such indication by the user equipment to the radio access network node may trigger beam refinement, or a change in beam skipping sequence, by the radio access network node.

### BRIEF DESCRIPTION OF THE DRAWINGS

FIG. 1 illustrates wireless communication system environment.

FIG. 2A illustrates an example embodiment of different beam skipping sequences.

FIG. 2B illustrates different active periods of different beam skipping sequences.

FIG. 3 illustrates an example embodiment synchronization signal architecture with a beam skipping sequence indication compared to a signal architecture without a beam skipping sequence indication.

FIG. 4A illustrates an example random-access occasion indication.

FIG. 4B illustrates an example environment with two random access channel occasions corresponding to a beam.

FIG. 5 illustrates a timing diagram of an example embodiment of a user equipment using a beam skipping sequence indication to monitor and decode a synchronization signal block signal transmitted by a radio access network node.

FIG. 6 illustrates flow diagram of an example embodiment method of a user equipment using a beam skipping sequence indication to monitor and decode a synchronization signal block signal transmitted by a radio access network node.

FIG. 7 illustrates a block diagram of an example method embodiment.

FIG. 8 illustrates a block diagram of an example user equipment embodiment.

FIG. 9 illustrates a block diagram of an example non-transitory machine-readable medium embodiment.

FIG. 10 illustrates an example computer environment.

FIG. 11 illustrates a block diagram of an example wireless user equipment.

FIG. 12 illustrates an example beam skipping configuration.

### DETAILED DESCRIPTION OF THE DRAWINGS

As a preliminary matter, it will be readily understood by those persons skilled in the art that the present embodiments are susceptible of broad utility and application. Many methods, embodiments, and adaptations of the present application other than those herein described as well as many variations, modifications and equivalent arrangements, will be apparent from or reasonably suggested by the substance or scope of the various embodiments of the present application.

Accordingly, while the present application has been described herein in detail in relation to various embodiments, it is to be understood that this disclosure is illustrative of one or more concepts expressed by the various example embodiments and is made merely for the purposes of providing a full and enabling disclosure. The following disclosure is not intended nor is to be construed to limit the present application or otherwise exclude any such other embodiments, adaptations, variations, modifications and equivalent arrangements, the present embodiments described herein being limited only by the claims appended hereto and the equivalents thereof.

As used in this disclosure, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component can be, but is not limited to being, a process running on a processor, a processor, an object, an executable, a thread of execution, computer-executable instructions, a program, and/or a computer. By way of illustration and not limitation, both an application running on a server and the server can be a component.

One or more components can reside within a process and/or thread of execution and a component can be localized on one computer and/or distributed between two or more computers. In addition, these components can execute from various computer readable media having various data structures stored thereon. The components can communicate via local and/or remote processes such as in accordance with a signal having one or more data packets (e.g., data from one component interacting with another component in a local system, distributed system, and/or across a network such as the internet with other systems via the signal). As another example, a component can be an apparatus with specific functionality provided by mechanical parts operated by electric or electronic circuitry, which is operated by a software application or firmware application executed by a processor, wherein the processor can be internal or external to the apparatus and executes at least a part of the software or firmware application. In yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

The term “facilitate” as used herein is in the context of a system, device or component “facilitating” one or more actions or operations, in respect of the nature of complex computing environments in which multiple components and/or multiple devices can be involved in some computing operations. Non-limiting examples of actions that may or may not involve multiple components and/or multiple devices comprise transmitting or receiving data, establishing a connection between devices, determining intermediate results toward obtaining a result, etc. In this regard, a computing device or component can facilitate an operation by playing any part in accomplishing the operation. When operations of a component are described herein, it is thus to be understood that where the operations are described as facilitated by the component, the operations can be optionally completed with the cooperation of one or more other computing devices or components, such as, but not limited to, sensors, antennae, audio and/or visual output devices, other devices, etc.

Further, the various embodiments can be implemented as a method, apparatus or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable (or machine-readable) device or computer-readable (or machine-readable) storage/communications media. For example, computer readable storage media can comprise, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

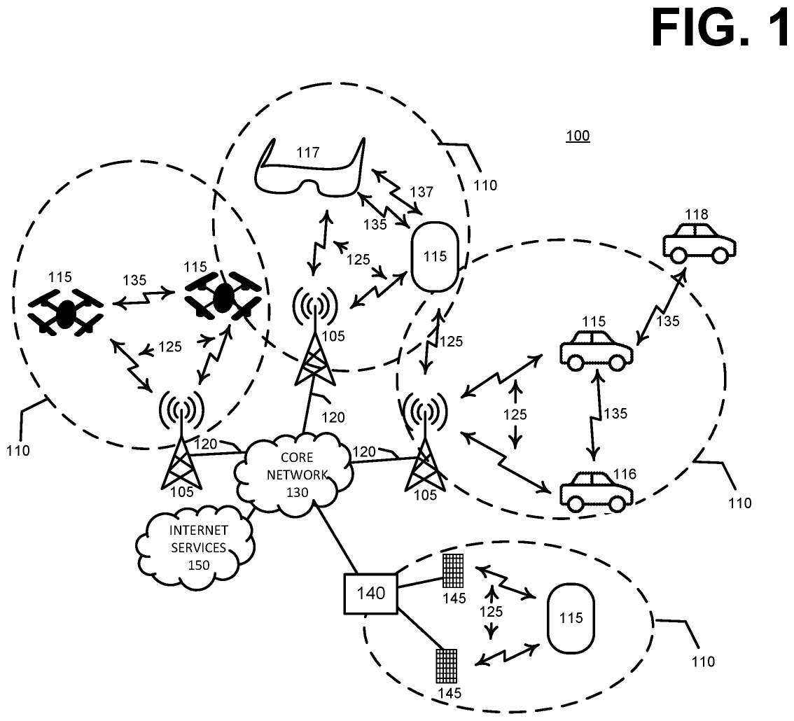

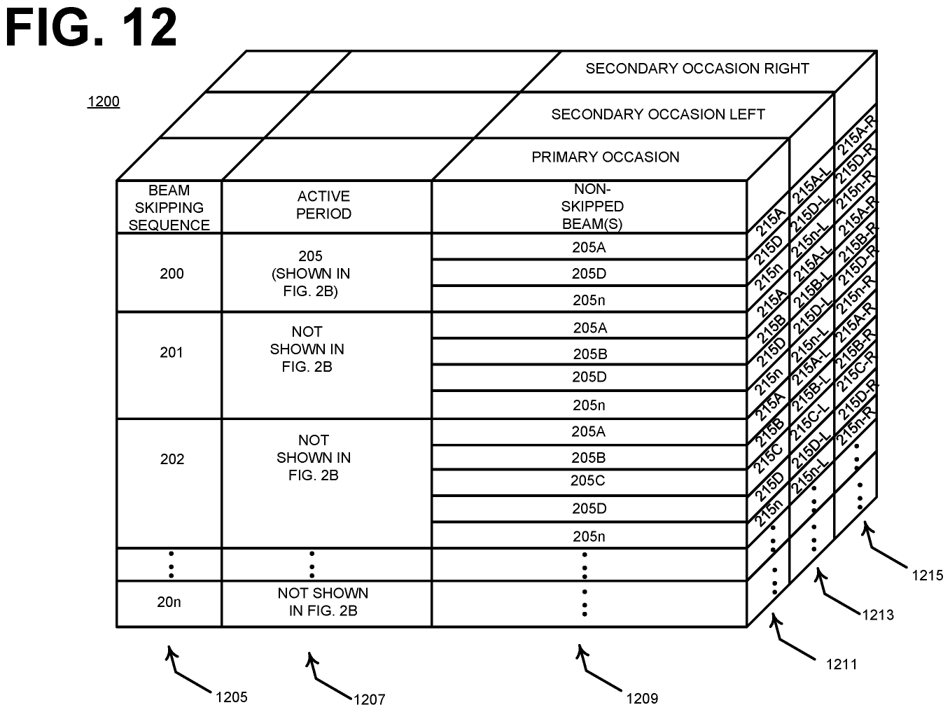

Turning now to the figures, FIG. 1 illustrates an example of a wireless communication system 100 that supports blind decoding of PDCCH candidates or search spaces in accordance with one or more example embodiments of the present disclosure. The wireless communication system 100 may include one or more base stations 105, one or more user equipment (“UE”) devices 115, and core network 130. In some examples, the wireless communication system 100 may comprise a long-range wireless communication network, that comprises, for example, a Long Term Evolution (LTE) network, an LTE-Advanced (LTE-A) network, an LTE-A Pro network, or a New Radio (NR) network. In some examples, the wireless communication system 100 may support enhanced broadband communications, ultra-reliable (e.g., mission critical) communications, low latency communications, communications with low-cost and low-complexity devices, or any combination thereof. As shown in the figure, examples of UEs 115 may include smart phones, automobiles or other vehicles, or drones or other aircraft. Another example of a UE may be a virtual reality appliance 117, such as smart glasses, a virtual reality headset, an augmented reality headset, and other similar devices that may provide images, video, audio, touch sensation, taste, or smell sensation to a wearer. A UE, such as VR appliance 117, may transmit or receive wireless signals with a RAN base station 105 via a long-range wireless link 125, or the UE/VR appliance may receive or transmit wireless signals via a short-range wireless link 137, which may comprise a wireless link with a UE device 115, such as a Bluetooth link, a Wi-Fi link, and the like. A UE, such as appliance 117, may simultaneously communicate via multiple wireless links, such as over a link 125 with a base station 105 and over a short-range wireless link. VR appliance 117 may also communicate with a wireless UE via a cable, or other wired connection. A RAN, or a component thereof, may be implemented by one or more computer components that may be described in reference to FIG. 12.

Continuing with discussion of FIG. 1, base stations 105 may be dispersed throughout a geographic area to form the wireless communication system 100 and may be devices in different forms or having different capabilities. The base stations 105 and the UEs 115 may wirelessly communicate via one or more communication links 125. Each base station 105 may provide a coverage area 110 over which UEs 115 and the base station 105 may establish one or more communication links 125. Coverage area 110 may be an example of a geographic area over which a base station 105 and a UE 115 may support the communication of signals according to one or more radio access technologies.

UEs 115 may be dispersed throughout a coverage area 110 of the wireless communication system 100, and each UE 115 may be stationary, or mobile, or both at different times. UEs 115 may be devices in different forms or having different capabilities. Some example UEs 115 are illustrated in FIG. 1. UEs 115 described herein may be able to communicate with various types of devices, such as other UEs 115, base stations 105, or network equipment (e.g., core network nodes, relay devices, integrated access and backhaul (IAB) nodes, or other network equipment), as shown in FIG. 1.

Base stations 105 may communicate with the core network 130, or with one another, or both. For example, base stations 105 may interface with core network 130 through one or more backhaul links 120 (e.g., via an S1, N2, N3, or other interface). Base stations 105 may communicate with one another over the backhaul links 120 (e.g., via an X2, Xn, or other interface) either directly (e.g., directly between base stations 105), or indirectly (e.g., via core network 130), or both. In some examples, backhaul links 120 may comprise one or more wireless links.

One or more of base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a bNodeB or gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, a personal computer, or a router. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or smart meters, among other examples.

UEs 115 may be able to communicate with various types of devices, such as other UEs 115 that may sometimes act as relays as well as base stations 105 and the network equipment including macro eNBs or gNBs, small cell eNBs or gNBs, or relay base stations, among other examples, as shown in FIG. 1.

UEs 115 and base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. Wireless communication system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by UEs 115. A carrier may be operated in a standalone mode where initial acquisition and connection may be conducted by UEs 115 via the carrier, or the carrier may be operated in a non-standalone mode where a connection is anchored using a different carrier (e.g., of the same or a different radio access technology).

Communication links 125 shown in wireless communication system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications e.g., in a TDD mode).

A carrier may be associated with a particular bandwidth of the radio frequency spectrum, and in some examples the carrier bandwidth may be referred to as a “system bandwidth” of the carrier or the wireless communication system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communication system 100 (e.g., the base stations 105, the UEs 115, or both) may have hardware configurations that support communications over a particular carrier bandwidth or may be configurable to support communications over one of a set of carrier bandwidths. In some examples, the wireless communication system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE. A wireless communications resource may refer to a combination of a radio frequency spectrum resource, a time resource (e.g., a search space), or a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for a UE 115 may be restricted to one or more active BWPs.

The time intervals for base stations 105 or UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods e.g., depending on the length of the cyclic prefix prepended to each symbol period). In some wireless communication systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communication system 100 and may be referred to as a transmission time interval (TTI). In some examples, the TTI duration (e.g., the number of symbol periods in a TTI) may be variable. Additionally, or alternatively, the smallest scheduling unit of the wireless communication system 100 may be dynamically selected (e.g., in bursts of shortened TTIs (STTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of UEs 115. For example, one or more of UEs 115 may monitor or search control regions, or spaces, for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115. Other search spaces and configurations for monitoring and decoding them are disclosed herein that are novel and not conventional.

A base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of a base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., UEs 115 in a closed subscriber group (CSG), UEs 115 associated with users in a home or office). A base station 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communication system 100 may include, for example, a heterogeneous network in which different types of the base stations 105 provide coverage for various geographic coverage areas 110 using the same or different radio access technologies.

The wireless communication system 100 may support synchronous or asynchronous operation. For synchronous operation, the base stations 105 may have similar frame timings, and transmissions from different base stations 105 may be approximately aligned in time. For asynchronous operation, base stations 105 may have different frame timings, and transmissions from different base stations 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communication system 100 may be configured to support ultra-reliable communications or low-latency communications, or various combinations thereof. For example, the wireless communication system 100 may be configured to support ultra-reliable low-latency communications (URLLC) or mission critical communications. UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). Communication link 135 may comprise a sidelink communication link. One or more UEs 115 utilizing D2D communications, such as sidelink communication, may be within the geographic coverage area 110 of a base station 105. Other UEs 115 in such a group may be outside the geographic coverage area 110 of a base station 105 or be otherwise unable to receive transmissions from a base station 105. In some examples, groups of UEs 115 communicating via D2D communications may utilize a one-to-many (1:M) system in which a UE transmits to every other UE in the group. In some examples, a base station 105 facilitates the scheduling of resources for D2D communications. In other cases, D2D communications are carried out between UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more RAN network nodes (e.g., base stations 105) using vehicle-to-network (V2N) communications, or with both. In FIG. 1, vehicle UE 116 is shown inside a RAN coverage area and vehicle UE 118 is shown outside the coverage area of the same RAN. Vehicle UE 115 wirelessly connected to the RAN may be a sidelink relay to in-RAN-coverage-range vehicle UE 116 or to out-of-RAN-coverage-range vehicle UE 118.

The core network 130 may provide user authentication, access authorization, tracking, Internet Protocol (IP) connectivity, and other access, routing, or mobility functions. Core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for UEs 115 that are served by the base stations 105 associated with core network 130. User IP packets may be transferred through the user plane entity, which may provide IP address allocation as well as other functions. The user plane entity may be connected to IP services 150 for one or more network operators. IP services 150 may comprise access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices e.g., radio heads and ANCs) or consolidated into a single network device (e.g., a base station 105).

The wireless communication system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communication system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communication system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communication system 100 may utilize both licensed and unlicensed radio frequency spectrum bands. For example, the wireless communication system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as base stations 105 and UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally, or alternatively, an antenna panel may support radio frequency beamforming for a signal transmitted via an antenna port.

Base stations 105 or UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, a base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by a base station 105 in different directions and may report to the base station an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). A UE 115 may report feedback that indicates precoding weights for one or more beam directions, and the feedback may correspond to a configured number of beams across a system bandwidth or one or more sub-bands. A base station 105 may transmit a reference signal (e.g., a cell-specific reference signal (CRS), a channel state information reference signal (CSI-RS)), which may be precoded or unprecoded. A UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communication system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

### Network Energy Saving

Energy or power saving is desirable in cellular networks, for both network equipment and user equipment. An objective of Network Energy Saving (“NES”) mode is to facilitate a RAN node, that may be experiencing high power consumption, limited battery capacity, or power source disruptions, dynamically relaxing support of one or more radio functions, or one or more radio services, that the RAN node may otherwise support, until an improvement in power situation is achieved, for example, an off-site power source of the RAN node being restored such that the RAN no longer relies on power from a battery on-site at the RAN, or until capacity of an on-site battery is restored to a configured level. Implementing NES may facilitate cost efficiency or power efficiency at the RAN node, (e.g., activating NES mode during a light load time for a RAN that experiences a high variance rate of traffic loads throughout a given day), or may facilitate service continuity, especially for emergency services/calls, in case of power source disruptions/outage.

Accordingly, a cell's RAN node may dynamically implement NES mode to temporarily halt support of, or offering of, high-energy-consumption radio services for a determined or configured period. Non-limiting examples of power-heavy radio services, or operations, include ultra-fast scheduling associated with mini-slot scheduling for latency-critical services, data duplication for enhanced radio reliability, and others. For already-connected user equipment (e.g., a user equipment that is RRC CONNECTED with a RAN), the RAN may already be aware of services, traffic types, and quality of service (QOS) targets, corresponding to traffic flows associated with the already-connected user equipment. Thus, the RAN node can determine to avoid NES mode activation to avoid negatively impacting critical traffic currently being served to the user equipment by the RAN. However, the RAN node may not be aware of user equipment in an IDLE mode that are not actively connected to the RAN node even if the idle mode user equipment are within a coverage area, or range, of the RAN and the RAN node may not be aware of target QoS targets or services that may be needed, or requested, by an idle user equipment when user equipment later initiates connection to the RAN node. Thus, according to current implementations, an idle mode user equipment device, which may be camped on a NES-mode-activated RAN node, may only be aware of the NES mode activation by the RAN and the services which are currently not offered or not supported by the RAN node, when the user equipment initiates connection establishment procedures with the RAN node. Such initiation of connection procedures may comprise user equipment devices executing random access procedures and corresponding subsequent power-heavy and signaling-heavy connection establishment procedures. Only after initiating and connecting to the RAN node may the user equipment become aware that the RAN node has activated NES mode and is not currently offering or supporting a service or radio function that the user equipment may need to request, which may result in the user equipment discarding the established connection with the RAN and attempting reselection of another neighboring RAN node. Such connecting of the user equipment to the RAN node may lead to energy inefficiency at both the RAN node and at the user equipment as well as wasted signaling overhead and a delayed network access of impacted idle devices.

Currently, several schemes for implementing network power savings may be implemented. An example of a currently implemented NES mode procedure is Aggregated Paging Occasions (“APO”), wherein user equipment devices are aggregated to monitor and blindly decode the same paging occasion. This reduces the total number of paging occasions a RAN node has to transmit but comes at the expense of idle mode devices waking up and decoding the same paging occasion that may include paging information for only a single user equipment device, (e.g., a paging ‘false alarm’). With APO, benefits of NES may be overshadowed by increased energy consumption at aggregated user equipment devices due to paging false alarms.

Another example of a currently implemented NES mode procedure is for a cell/RAN node to shut down and not accept new connection requests from user equipment that are not currently connected to the cell/RAN. Shutting down the accepting of new connection requests, or even stopping current device connections for all or part of one or more active services, is a straightforward NES solution, but one that may cause a negative impact on a user equipment's achievable quality of service. Furthermore, shutting down accepting of new connection request may lead to coverage gaps, where an idle user equipment may be unaware of, or ‘blind’ to, the halting of services resulting in the user equipment attempt to connect to the RAN (and thus expending battery power and time resources of the user equipment) notwithstanding that the RAN is not currently offering a service that the user equipment needs to the RAN. In case of a need for an emergency service, such as fire, rescue, law enforcement, etc., a user equipment being blind to radio services that have been deactivated by a RAN may impose a safety risk to a user of the blind user equipment.

Idle mode operations comprise several procedures for user equipment devices in idle mode to perform, for example: determining coverage level/signal strength corresponding to surrounding cells; camping on, or selecting, a certain cell/RAN; or monitoring a detected coverage level/signal strength of the cell/RAN in case the user equipment moves or in case radio conditions change. Idle mode devices may be viewed as active user equipment that are not connected to a cell/RAN, thus the RAN network is not aware of locations of idle mode devices and a density of idle user equipment.

When a user equipment device is turned on, the user equipment device searches for and attempts decoding synchronization signal blocks (“SSB”) signals transmitted by surrounding RAN nodes/cells—SSB signals are typically the sole always-transmitted signals of a 5G RAN node. An SSB enables idle mode devices to, for example: obtain downlink radio frequency (“RF”) receiver synchronization with the surrounding cells/RANs; determine cell identifiers of the surrounding cells/RANs; and determine coverage levels using SSB downlink reference signal (e.g., the user equipment may determine signal strength based on reference signal received power (“RSRP”) corresponding to each of the detected cells/RANs).

Accordingly, an idle mode device, based on detected SSBs, and determined coverage levels of surrounding cells/RANs corresponding to the determined cell/RAN identifiers, may select a stand-by cell/RAN to camp on that offers the best coverage level/determined signal strength. The user equipment initiates a connection to the stand-by cell/RAN (e.g., initiates an RRC connection) when the user equipment needs to connect to the network, (e.g., for receiving a call or for initiating an uplink data session without using time to perform cell selection, since the cell/RAN selection has already been performed). Thus, cell/RAN selection procedures are typically periodically executed regardless of whether the idle mode device needs to connect to the cell/RAN.

An idle mode device may initiate cell re-selection using the same procedure as cell selection but searching for another cell than the one previously selected/currently-selected at an instant according to an idle mode period configured at the user equipment or periodically according to a configuration received from the cell/RAN. Cell/RAN re-selection benefits a user equipment because a given selected cell/RAN that was optimum with respect to the user equipment at one time may not provide a determined strongest signal strength at a later time, which scenario may occur if the idle mode user equipment is moving between cells or if channel radio conditions change. Thus, when a coverage degradation of a currently selected cell is detected (based on a defined set of conditions being satisfied), an idle mode device may initiate idle-mode reselection. A cell/RAN node is typically not aware of a reselection determination made by an idle mode device.

For a given selected cell, an idle mode device monitors SSB information transmitted from the cell/RAN and monitors the determined paging occasion(s) corresponding to the cell/RAN. Monitoring SSB information facilitates an idle mode device staying up-to-date regarding coverage levels of the selected cell/RAN and triggering cell-reselection if needed to support an incoming call or data traffic transmission.

Thus, although cells/RANs transmitting SSB signals facilitates user equipment transition from a low-power IDLE mode to a higher power CONNECTED mode, transmission of SSB blocks is an energy-heavy operation at a cell/RAN. When an idle mode user equipment connects to a RAN node (e.g., transitions from idle to connected mode), the user equipment ‘assumes’ that services, or QoS profiles that it is pursuing, or requesting, are offered by the currently selected cell. If an idle mode user equipment transitions to a connected mode and then determines that a service that the user equipment needs is inactive at the RAN it is connected to, the UE has expended battery power and time resources in establishing the fruitless connection.

As discussed, an SSB signal is a 5G signal that may be always on, or always transmitted via the 5G radio interface, regardless of user equipment capability or battery condition. A user equipment uses information contained in, or corresponding to, an SSB signal to identify the existence of the cell/RAN that transmits the SSB signal, received coverage level from the cell/RAN (e.g., the coverage bar on a mobile handset screen), as well as additional cell information used for cell connection establishment and access by the user equipment. To reduce power consumption at a cell/RAN, for example when a RAN may be operating on a battery or just to reduce costs paid to an electric utility company for offsite power supplied to the RAN, relaxation of regular SSB signal transmission may be desirable. However, without continuous, regular transmission of an SSB signal, user equipment in an idle mode that are within a range such that the user equipment has an adequate coverage level to facilitate communication with the RAN may not identify a cell/RAN and may treat lack of a SSB with an adequately strong signal as a coverage gap, even if the user equipment is actually within a range of a RAN having a strong coverage at the user equipment such that adequate communication could be facilitated. Without being able to receive an SSB from a cell/RAN, network communication service to an idle user equipment cannot be established due to lack of SSB transmission from the cell/RAN, which may be power-limited due to operating on battery power, for example. Accordingly, user equipment may attempt searching for service from another cell/RAN instead. Thus, SSB signal transmission relaxation may come at the expense of degraded network access performance, especially in the case where coverage of an available geospatially adjacent cell (e.g., available because the adjacent RAN is transmitting SSB signaling messages) is much poorer than the coverage level of the RAN that has ‘relaxed’, or suspended, transmission of SSB signaling messages. Camping on a RAN that provides poor coverage instead of a RAN that may actually be closer, or that may provide a stronger signal strength, is suboptimal, and may be due to the user equipment not being aware of a RAN that could provide stronger signal strength because of suspended SSB signal transmission from the otherwise more optimal RAN.

Over the higher 5G spectrum frequencies, bandwidth energy of downlink beams is more sharply focused in more narrow beamwidths relative to beam shapes and sizes for lower frequencies. Thus, more beams are needed to facilitate coverage of a RAN as compared to a number of beams needed to facilitate geographic coverage by a RAN at lower frequencies. For example, hundreds of beams may be used at higher 5G frequency ranges. This may lead to a RAN transmitting a full SSB signal block via all beams individually and sequentially (all-beam sweeping) in a time domain or frequency domain because the RAN node is not aware of where idle mode user equipment devices are located within the RAN's coverage area. SSB beam sweeping of all beams can be energy inefficient from the perspective of a RAN that is not serving more than a few active user equipment devices, and some beams (e.g., beams focused in particular directions) can be practically non-essential when those few user equipment devices could be reasonably served by an adjacent other beam.

Full SSB beam sweeping (repeating full SSB transmission on all beams sequentially) is network energy inefficient, especially over higher spectrum frequencies where there are many available beams. For example, over the 24 GHz spectrum, the SSB block transmission can be swept over hundreds of downlink beams. Thus, there is a need to optimize SSB beam sweeping by a RAN node to minimize energy use while facilitating idle mode user equipment in connecting to the RAN node.

Embodiments described herein facilitate dynamic SSB beam sweeping instead of just relaxing a periodicity of transmitting SSB signals over all configured downlink beams corresponding to a RAN. Unlike conventional all-beam sweeping that increases SSB transmission periodicity (e.g., SSB signals are less frequently transmitted albeit vial all beams), which practically ensures degradation of UE-RAN access performance due to the longer time between transmission of SSB signals, embodiments disclosed herein facilitate adaptive SSB beam sweeping procedures that reduce power consumption of SSB transmission without the access performance (e.g., time for a UE to transition from IDLE mode to CONNECTED mode with a RAN) that typically is caused by lengthening of SSB transmission beam sweeping periodicity.

### Adaptive Beam Skipping of Synchronization Signals

Embodiments disclosed herein facilitate sweeping SSB transmissions over a dynamically determined subset of available downlink beams that may be serving more than a configured number of devices. Reducing the number of beam sweeping SSB transmissions by skipping the transmission of SSB signals via some beams may reduce energy consumption by a RAN node. Beam skipping may impact network access performance with respect to some idle mode devices that may be attempting to access the RAN and that may be located within a coverage of one or more beams skipped for SSB signal transmission. Accordingly, other embodiments may enhance beam skipping embodiments via recovery or refinement mechanisms whereby a RAN node may determine whether an accessing device may be utilizing a best beam for accessing the RAN node (e.g., a signal strength corresponding to a non-skipped beam used by the user equipment is highest at the user equipment than signal strengths corresponding to other beams) or whether the user equipment may be using a second or third best beam because the best beam (or second best beam) may be a skipped beam. In an embodiment, the RAN node may determine to offer more SSB beam sweeping events to accommodate user equipment devices that may not be using a best beam to connect to the RAN node (e.g., on-demand beam refinement in which beams skipped according to a given beam skipping sequence are activated during an active period of a different beam skipping sequence such that that energy for the skipped and then non-skipped beam(s) is only consumed when determined by the RAN that the user equipment would benefit by being served by a beam being skipped according to a current beam skipping sequence). Accordingly, a network power saving gain may be realized by skipping SSB signal transmission via lightly used, or not used, beams while facilitating user equipment connecting to the RAN without any, or with minimal, impact on network access by user equipment.

Instead of SSB signals being transmitted across all available downlink beams to facilitate cell coverage for user equipment in an idle mode, embodiments disclosed herein may transmit SSB signals via determined available beams that are dynamically determined based on, or adapted to, real-time conditions of idle mode user equipment device locations and corresponding serving downlink beams and network energy consumption conditions at a RAN that may transmit the beams.

Multiple SSB beam sweeping patterns, which may be referred to as beam skipping sequences, or beam skipping subsequences, may be predefined, or configured, at a RAN node and at user equipment that may be in an area, such as a tracking area, corresponding to the RAN node. A configured SSB beam skipping sequence may be implemented by a RAN to skip transmission, during an active period of the beam skipping sequence, of SSB signaling via downlink beams configured as skipped beams. For example, for four available downlink beams corresponding to a RAN node that may be generally directed toward a user equipment, the RAN node may skip transmission of SSB signals according to a first SSB beam skipping sequence, or subsequence, at time t₀ by transmitting SSB block signals sequentially transmitted via beam one and beam four while skipping transmission of SSB signals via beams two and three. At a next SSB transmission instant t₁, SSB blocks may be transmitted via beams one, two, and four. And at a following SSB transmission instant t₂, SSB blocks may be transmitted via all beams one, two, three, and four, (e.g., ‘fully swept’ because all four available beams were used to transmit SSB signaling at the third burst instant). An active period of the selected SSB beam skipping may comprise transmission of SSB signals according to three different subsequences over the three SSB instants t₀, t₁, and t₂, or an active period may be a period, corresponding to a subsequence corresponding one instant t₀, t₁, or t₂. In the example, according to a beam skipping sequence that comprises he three different subsequences, SSB signals are transmitted three out of the three SSB instants via beams one and four, two out of the three SSB instants via beam two, and only one out of the three SSB instants via beam 3.

A RAN node may determine to implement a beam skipping sequence, or subsequence, based on the RAN node detecting a lower number of idle mode user equipment devices attempting network access via the RAN node via beam two, and even a lower number via beam three, because always transmitting SSB signal repetitions over beams two and three would likely waste energy consumed by the RAN node. Accordingly, a RAN node may dynamically determine and transmit SSB signals according to a configured beam skipping sequence, or subsequence, and may indicate to user equipment the determined beam skipping sequence, or subsequence, according to which it will be transmitting, and not transmitting, SSB signals. A beam skipping sequence. or subsequence, may be indicated in a beam skipping sequence indication that is part of a transmitted SSB signal to make idle mode user equipment devices aware of a beam skipping sequence, or subsequence, that the RAN node will be implementing for transmitting SSB signals. Thus, user equipment can skip, or avoid, waking up and attempting to decode an SSB signal resources (e.g., time or frequency resources) corresponding to beams that will be skipped.

A RAN node may implement beam recovery procedures by configuring user equipment devices with multiple random-access occasions (e.g., primary, and secondary, or more, occasions), associated with each active (e.g., non-skipped) SSB beam, and an SSB coverage threshold. A user equipment may determine beams that are to be skipped according to a current SSB beam skipping sequence based on a configured beam skipping sequence indicated in a beam skipping sequence indication received from the RAN. The user equipment may determine a received SSB coverage (e.g., signal strength corresponding to SSB signaling transmitted by the RAN node) corresponding to active, non-skipped beams. If the user equipment determines a received SSB coverage below a configured SSB coverage criterion (e.g., a threshold configured in the user equipment), the user equipment may transmit a subsequent random-access preamble via a configured secondary random-access occasion instead of via a configured primary random-access occasion. Use of a secondary random access occasion may facilitate notifying the RAN node that the user equipment has received a degraded coverage level (e.g., signals strength lower than a configured threshold) via a beam corresponding to the secondary random access occasion, thus being indicative to the RAN node of the likelihood that beams that might have otherwise provided a better coverage, or better signal strength, to the user equipment are beams that have been skipped according to the current beam skipping sequence. Accordingly, based on receiving a random access preamble, or a random access code, via a secondary random access occasion corresponding to a non-skipped beam, the RAN node may implement beam refinement on an on-demand basis, to facilitate the user equipment that transmitted the random access code via the secondary random access occasion possibly determining a skipped beam as providing better coverage, or signal strength, to the user equipment than the non-skipped beam. Beam refinement may comprise the RAN node indicating, via an SSB signal transmitted via a currently non-skipped beam, a change to a different beam skipping sequence, or to a fully swept sequence, that does not skip a beam adjacent the beam corresponding to the secondary random-access occasion via which the user equipment transmitted the random-access code. If a RAN node receives a random-access preamble via a primary random-access occasion, the RAN node may determine, or ‘assume’, that a beam corresponding to the random access occasion is a beam that will provide the best signal strength/coverage at the user equipment and that no additional beam refinement (e.g., changing a beam skipping sequence so as not to skip a beam that was skipped according to a current beam skipping sequence) is needed to accommodate the user equipment. Thus, skipping SSB transmission repetitions over multiple downlink beams to reduce energy consumed at the RAN, network-access performance with respect to the user equipment via the skipped beams is not, or is minimally, negatively impacted.

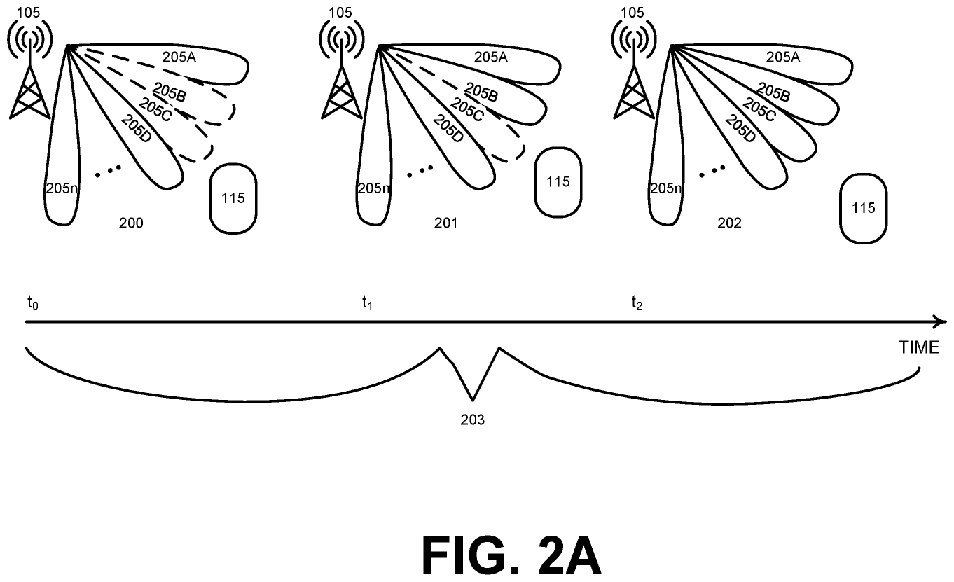

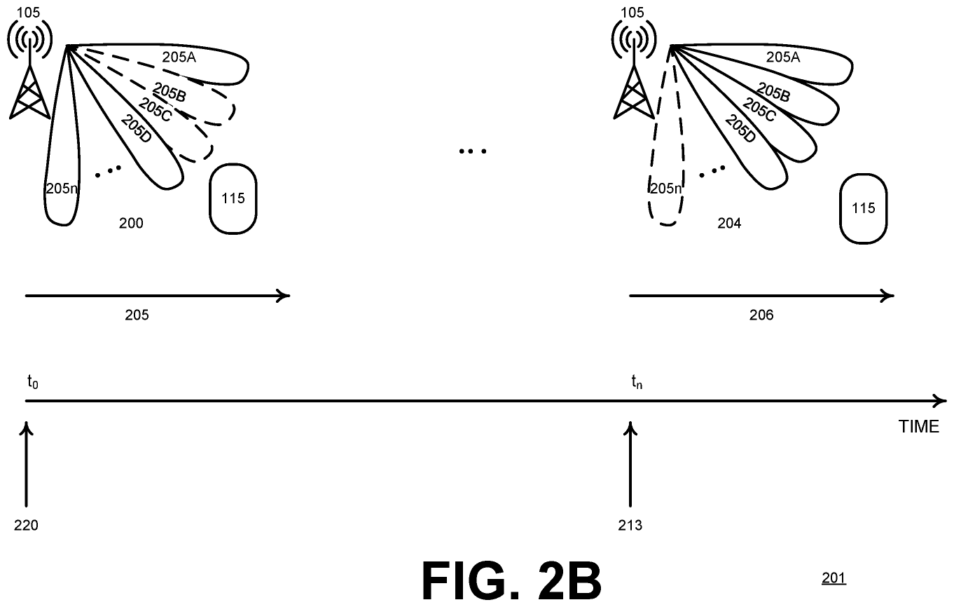

In an embodiment, multiple SSB beam sweeping patterns, or sequences, may be configured, or predefined. As illustrated in FIG. 2A, a beam skipping sequence 200, which may be a subsequence of a sequence 203, may comprise a first beam-skipping sweep sequence, or pattern. First beam-skipping sequence 200 may facilitate RAN node 105 transmitting SSB signaling via determined downlink beams and refraining from transmitting SSB signals via other (e.g., skipped) downlink beams during an active period corresponding to sequence 200. As shown in FIG. 2A, of four available downlink beams (e.g., ‘available beams’ may refer to beams having directions via which RAN 105 may be configured to transmit SSB signals), first beam-skipping sequence 200 may facilitate sequentially transmitting a first round, or iteration, of SSB signaling, beginning at time t₀, via beam 205A and via beam 205D, thus ‘skipping’ transmission of SSB signaling via beams 205B and 205C. At a next SSB transmission instant, or time, t₁ configured for RAN 105 to transmit SSB signaling, SSB signals may be transmitted according to beam skipping sequence 201 via beams 205A, 205B, and 205D. And at another SSB transmission burst instant at time t₂, SSB blocks may be transmitted according to beam skipping sequence 202 via beams, 205A, 205B, 205C, 205D, . . . 205n (e.g., “fully swept” insofar as RAN 105 uses all configured downlink beams to transmit SSB signaling). In some embodiments, determined beam skipping sequences 200, 201, and 202 may be referred to as subsequences and a full beam skipping sequence 203 may comprise the sub sequences over a period that comprises the three SSB instants. In other embodiments, beam skipping sequences 200, 201, and 202 may be referred to simply as beam skipping sequences. Thus, a determined full beam skipping sequence 203 may facilitate transmitting by RAN 105 SSB signaling via beams 205A and 205D at three out of three configured SSB transmission instants t₀, t₁, and t₂; via beam 205B at two out of the three configured SSB transmission instants, and via beam 205C one out of the three configured SSB instants. RAN 105 may determine to implement full beam skipping sequence 203, one of beam skipping sequences 200, 201, 202, or a combination thereof, based on determining that a number of user equipment devices 115 that have attempted to transition from an idle mode to a connected mode with the RAN via one or more of beams 205 satisfies a configured transition criterion. In an embodiment, the transition criterion may be satisfied by fewer than a configured, or determined, number of user equipment devices attempting to transition from an IDLE mode to a CONNECTED mode with RAN 105 via one or more beams 205 during a configured first transition period.

If RAN 105 determines that the transition criterion is satisfied, the RAN may determine that always transmitting SSB signal repetitions over beam 205B or beam 205C is wasteful or power at the RAN if there are not many, if any, user equipment devices that have attempted to connect with the RAN via beams 205B or 205C. Accordingly, RAN 105 may dynamically transmit an SSB beam skipping sequence indication, as part of a transmitted SSB signal, to be used by user equipment devices in an idle mode to select which SSB beams the RAN will be skipping, thus facilitating the idle user equipment remaining idle instead of waking up and attempting to decode SSB resources for the beams that will be skipped according to the beam skipping sequence.

In an embodiment, RAN 105 may determine a number of user equipment devices attempting to transition from IDLE to CONNECTED mode via a given beam based on how many user equipment report the given beam as the best-experienced beams for transmitting or receiving (e.g., how many user equipment have determined to connect with RAN 105 via the given beam based on the given beam being determined by the user equipment as having a higher signal strength than other beams).

In an embodiment, in addition to dynamically using a determined beam skipping sequence, such as full beam skipping sequence 203, or sub sequences 200, 201, or 202 as described in reference to FIG. 2A, a RAN may implement beam recovery via a random-access occasion indication in an SSB signal message. For example, RAN 105 may configure user equipment devices with multiple random-access occasions, for example a primary random-access occasion and a secondary random-access occasion, associated with each active (e.g., non-skipped) beam, and with a corresponding SSB coverage criterion, such as a signal strength threshold. A user equipment attempting to transition from IDLE mode to CONNECTED mode may determine a current beam skipping sequence and identify based thereon which beams the RAN will skip according to the beam sweep pattern sequence, for example full beam skipping sequence 203, or one or more or subsequences 200, 201, or 202. The user equipment may then determine a received SSB coverage, or signal strength, corresponding to active, non-skipped beams.

A user equipment may determine a signal strength of a given beam to be suboptimal (e.g., a signal strength corresponding to the beam is below a configured preferred signal strength threshold), but there may not be an alternative beam if transmitting of an SSB signal via a beam that may have had a stronger signal strength is skipped according to full beam skipping sequence 203. On condition of a received SSB coverage/signal strength being below the configured preferred signal strength threshold, the user equipment may transmit a random-access preamble, responsive to an SSB signal received via the beam having the suboptimal signal strength, via a secondary random-access occasion instead of via the primary random-access occasion. Transmitting a random-access preamble via a second random access occasion may be indicative to the RAN that the user equipment, although it may be able to communicate with the RAN via the given suboptimal beam, may experience degraded communication performance due to the coverage level/signal strength corresponding to the suboptimal beam being less than the configured preferred signal strength threshold beam. The RAN may determine, based on having received a random-access preamble from a user equipment that the user equipment transmitted according to a second random-access occasion that the suboptimal beam is in fact a suboptimal beam with respect to the user equipment and may not be a beam that would provide a best service to the user equipment of all beams that the RAN is configured to use but that may have been skipped according to a current beam skipping sequence. Accordingly, based on the RAN having received, via a given beam that is not skipped during a beam sweep pattern sequence, a random-access preamble from a user equipment that was transmitted by the user equipment according to a configured secondary random-access occasion, the RAN can trigger beam refinement procedures (e.g., not skipping a skipped beam during a next beam skipping sequence), on an on-demand basis.

On the other hand, if a RAN receives a random-access preamble according to a configured primary random-access occasion, the RAN may determine based thereon that that a beam corresponding to the transmission of the random-access preamble is already a beam that will provide a best communication for the user equipment that transmitted the random-access preamble and that no further beam refinement is needed (e.g., the RAN may not need to refrain from skipping transmission of an SSB signal via a beam that was skipped according to a current beam skipping sequence). Thus, although transmission of SSB signals via multiple downlink beams may be skipped to facilitate network energy saving at the RAN, network-access performance via skipped beams may not be negatively impacted since transmission by a user equipment of a random-access preamble via a primary random-access occasion is indicative of a beam corresponding to the preamble being a beam with a signal strength that is higher than the configured preferred signal strength threshold.

As shown FIG. 2B, A RAN node may dynamically switch between multiple configured SSB beam skipping sequences, for example sequence 200 during period 205 beginning at instant 210 and sequence 204 during active period 206 beginning at instant 213 depending on, for example, real-time idle mode device location(s) of UE 115 or depending on network energy consumption conditions. Configured SSB beam skipping sequence 200 may be active for configured period 205, after which user equipment devices may resume operation according to SSB signals being transmitted via all available beam according to a fully swept beam skipping (e.g., with no beams being skipped), or according to a configured default SSB beam skipping sequence. Thus, during an active period of a SSB beam skipping sequence, a SSB signal transmission via a subset of available downlink beams may be dynamically adopted.

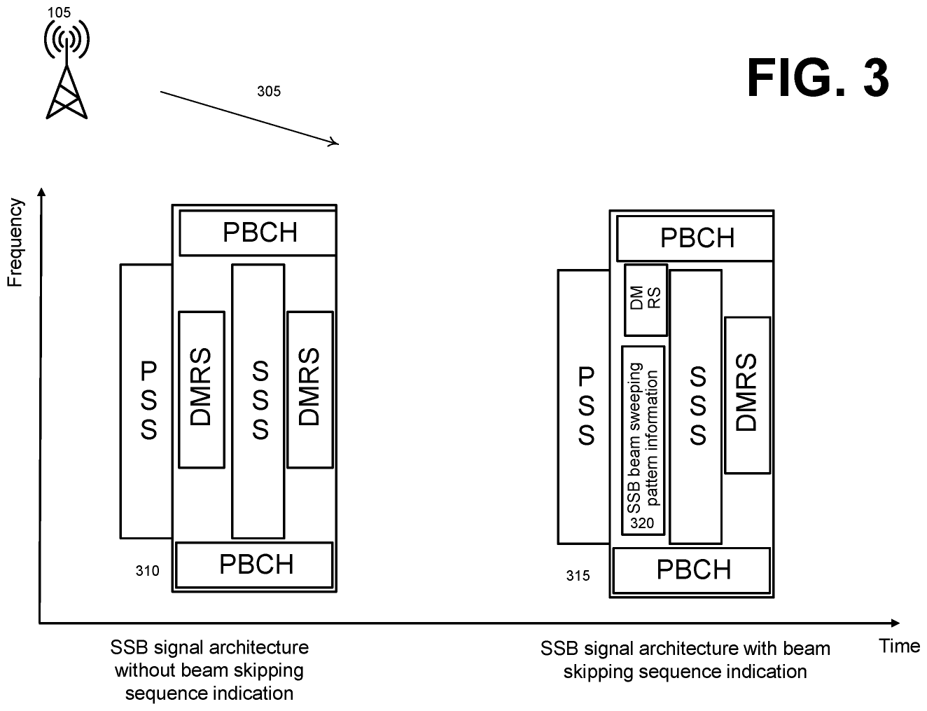

By a beam skipping indication, idle mode user equipment may be made aware of a current SSB beam skipping sequence so that the user equipment may avoid waking up and attempting to receive and decode SSB signals via resources corresponding to skipped, therefore avoiding unnecessary use of energy at the user equipment. Thus, a RAN node may transmit an SSB beam sweeping pattern information object 320 as shown in FIG. 3, on-the-go, as part of SSB 315. A SSB beam sweeping pattern information object may be referred to as a beam skipping sequence indication and may comprise information elements, such as, for example, an indication of an SSB beam skipping sequence in a list or codebook (e.g., a beam skipping configuration 1200 described in more detail in reference to FIG. 12) configured in a user equipment comprising one or more predefined/configured beam skipping sequence(s). A beam skipping sequence indication may comprise one or more active periods corresponding to the one or more configured beam skipping sequence. If, for example, a configured active period is longer than a time length of an indicated SSB bean skipping sequence, an idle mode device may determine that an indicated sequence will be partially or fully repeated until the end of the active period.

A beam skipping sequence indication 320 may comprise a random-access occasion indication indicative of one or more random access occasions, associated with each available (non-skipped) downlink beam of a beam skipping sequence. Because user equipment devices that may have previously connected with a RAN node via different adjacent beams may camp on the same beam (e.g., due to the other beams possibly being skipped according to a beam skipping sequence), the RAN node may determine to allocated multiple random access occasions for transmitting random access preambles corresponding to the beams adjacent to the skipped beams to allow for more decode capacity at the user equipment. This embodiment contrasts with conventional random-access implementations where a single resource set occasion can be associated with a downlink beam use to transmit SSB signaling 310.

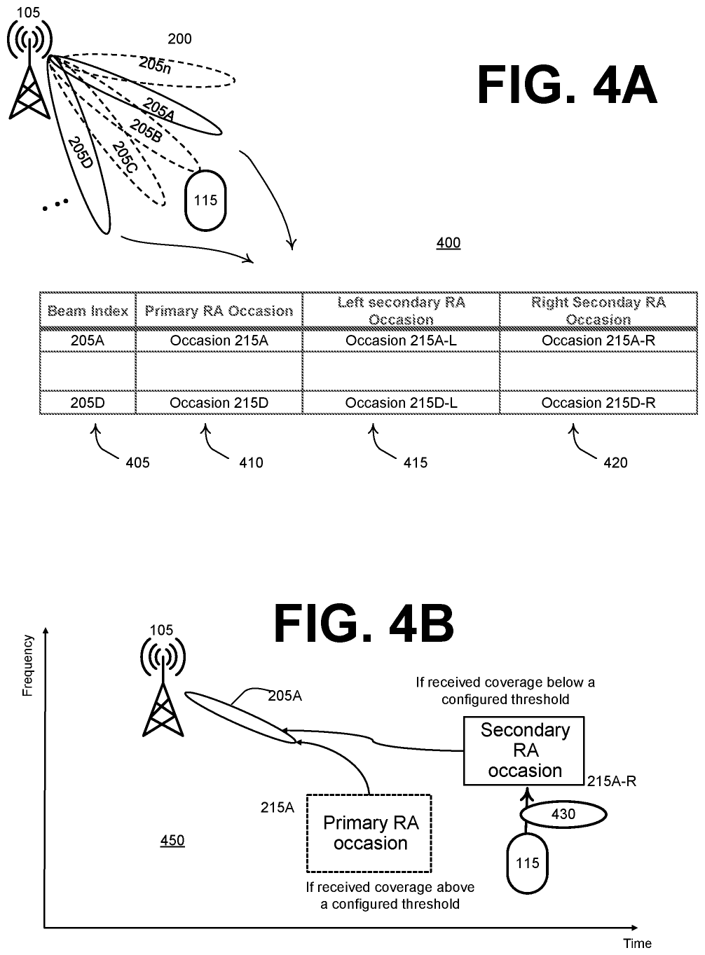

A RAN node 105 shown in FIG. 4 may adopt beam recovery procedures to facilitate, for example, user equipment location changes. A currently selected beam skipping pattern/sequence may not be sufficient if one or more user equipment are moving and if a beam skipped for transmission of SSB signaling may be a best beam for serving a number of idle mode user equipment. RAN node 115 may configure user equipment 115 with multiple resource occasions for random access associated with beams that are adjacent to beams that RAN 105 skips when transmitting SSB signaling according to a currently indicated beam skipping sequence. A configured random-access occasion may be a primary occasion 410, another random-access occasion may be a first secondary random access occasion 415 and yet another random access occasion may be a second secondary resource occasion 420. RAN 105 may configure user equipment 115 with a coverage criterion, for example a minimum SSB received coverage threshold (e.g., a signal strength threshold). If UE 115 determines that an SSB coverage level/signal strength satisfies the configured minimum SSB coverage threshold, the UE may transmit a random-access code, or preamble, via a primary resource occasion corresponding to the beam that that carried the SSB signal that the UE determined had a signal strength that satisfied the coverage criterion. Thus, RAN 105 may determine that UE is either being served by a best downlink beam (e.g., a beam having a highest signal strength as determined by the UE) that is not a skipped beam, or that the UE is being served by a beam, adjacent to a skipped beam (which might be a better beam than the beam currently serving the UE), that provides a signal strength that satisfies the coverage criterion.

However, if UE 115 is being served by a beam that has a signal strength that does not satisfy a configured coverage threshold, UE 115 may transmit a random-access code, or preamble, via a secondary resource occasion. As shown in FIG. 4A, UE115 appears to be directly in the beam path of beam 205B, and thus would likely receive a strong beam signal strength that satisfies a coverage criterion in beam 205B were not skipped (as indicated by dashed lines depicting beam 205B). UE 115 might also receive a strong signal from beam 205C if beam 205C were not skipped. UE115 may determine that a signal strength corresponding to beam 205A may not satisfy a coverage criterion threshold but may nevertheless be a higher signal strength than a signal strength corresponding to SSB signaling transmitted via non-skipped beam 205D. Based on configured beam sequence 200, UE115 may determine to transmit a random-access code, or preamble, via a secondary random access occasion resource 215A-R corresponding geospatially to a location to the right of beam 205A as shown in FIG. 4A instead of determining to transmit a random-access code, or preamble, via a secondary random access occasion resource 215D-L corresponding geospatially to a location to the left of beam 205D. (It will be appreciated that for purposes of discussion reference to ‘right’ refers to the clockwise direction when viewing FIG. 4A.) Accordingly, RAN 105 may determine that UE 115 may be best served by one of skipped beams 205B or 205C and not skipped beam 205n (which is to the left of beam 205A), based on receiving a random access code via secondary random access occasion resources 215A-R, and the RAN may determine to indicate to UE 115 a different beam skipping sequence, for example sequence 201 shown in FIG. 2A, according to which the RAN transmits SSB signaling via beam 205B. If RAN 105 had received a random-access code via secondary occasion resources 215A-L, the RAN may indicate to the user equipment a different beam skipping sequence according to which the RAN transmits SSB signaling via beam 205n. In one or more embodiments, secondary random access occasion resources may not be differentiated based on geospatial locations to the right or left of a currently non-skipped beam. In such embodiments, if only one secondary random access occasion resource set (e.g., time or frequency resources) is configured as corresponding to beam 205A, if RAN 105 receives a random access code from UE 115 via the secondary occasion resource that corresponding to beam 205A, depending on which other beams corresponding to the RAN are skipped or not skipped according to a currently implemented beam skipping sequence, the RAN may implement, and indicate to the UE via a beam skipping sequence 320 described in reference to FIG. 3, a different beam skipping sequence according to which the RAN will transmit SSB signaling via beam 205B and beam 205n. Thus, RAN 105 can implement beam refinement. Beam refinement may refer to RAN 105 making a change from implementing a current beam skipping sequence, such as, for example, sequence 200, to implementing at least one different beam skipping sequence according to which at least one beam adjacent to a non-skipped beam of the currently implemented beam skipping sequence is used for transmission of SSB signaling during an access attempt by UE 115 to connect with the RAN. RAN 105 may restrain transmission of traffic to UE 115 until the best beam to serve the user equipment has been determined by beam refinement.

As shown by FIG. 4B, UE 115 may be configured with an SSB coverage threshold. If a received/determined SSB coverage level from the best available SSB beam (e.g., strongest signal at the UE of non-skipped beams), for example beam 205A, is above the configured coverage threshold, the UE may transmit a random access preamble via primary random access occasion resources 215A, otherwise, the UE may transmit random access preamble 430 via secondary occasion resources 215A-R associated with the best available detected SSB beam 205A.

As shown in FIG. 12, a beam skipping sequence configuration 1200, or beam skipping configuration, may comprise a beam skipping sequence identification field 1205 comprising one or more beam skipping identifiers corresponding to one or more respective beam skipping sequences. Active period field 1207 may comprise an indication of an active period during which the corresponding beam skipping sequence identified in field 1205 will be implemented by a RAN. Non-skipped beam field 1209 may comprise beams that a RAN implementing the corresponding beam sequence will use to transmit SSB signaling. For each beam listed in non-skipped beam field 1209, a primary occasion resource set is given in primary random-access occasion field 1211, a first secondary random-access occasion resource set may be given in first secondary occasion field 1213, and a second secondary random-access occasion resource set may be given in second secondary occasion field 1215. A first secondary random-access occasion may be referred to as a left secondary random-access occasion and a second secondary random-access occasion may be referred to as a right secondary random-access occasion. A left secondary random-access occasion may correspond to a direction, with respect to the non-skipped beam to which the second random access occasion corresponds, toward a skipped beam to the left of the non-skipped beam and a right secondary random-access occasion may correspond to a direction, with respect to the non-skipped beam to which the second random access occasion corresponds, toward a skipped beam to the right of the non-skipped beam. The terms ‘right’ or ‘left’ may refer to direction of a progression used to transmit of SSB signals, for example as shown in FIG. 2A—‘right’ may correspond to a beam sequence that progresses in a clockwise direction and ‘left’ may correspond to a beam progression that moves in a counterclockwise direction. Thus, in FIG. 2A, skipped beam 205B of sequence 200 would be referred to as being an adjacent beam to the right of non-skipped beam 205A, and skipped beam 205C of sequence 200 would be referred to as being an adjacent beam to the right of skipped beam 205B. Thus, if UE in FIG. 2A were to transmit a random-access code via a secondary occasion 215A-R, RAN 115 could determine from configuration 1200 shown in FIG. 12 that UE 115 may be better served by beam 205B, or even beam 205C, and may determine to implement sequence 201 so that beam 205B would be used to transmit an SSB signal, or the RAN may determine to activate sequence 202 so that an SSB signal would be transmitted via 205C. If UE 115 in FIG. 2A were to transmit a random-access code via a secondary occasion 215A-L, RAN 115 could determine from configuration 1200 shown in FIG. 12 that UE 115 may be better served by a beam to the left of beam 205A and may determine to activate a beam skipping sequence according to which the RAN transmits SSB signals such that a currently skipped beam to the left of beam 205A is a non-skipped beans (it will be appreciated that beams to the left of beam 205A of sequence 200 are not shown in FIG. 2A). If UE 115 in FIG. 2A were to transmit a random-access code via a primary occasion 215A, RAN 115 could determine from configuration 1200 shown in FIG. 12 that UE 115 may be best served by beam 205A and thus determine not to change to a different beam skipping sequence.

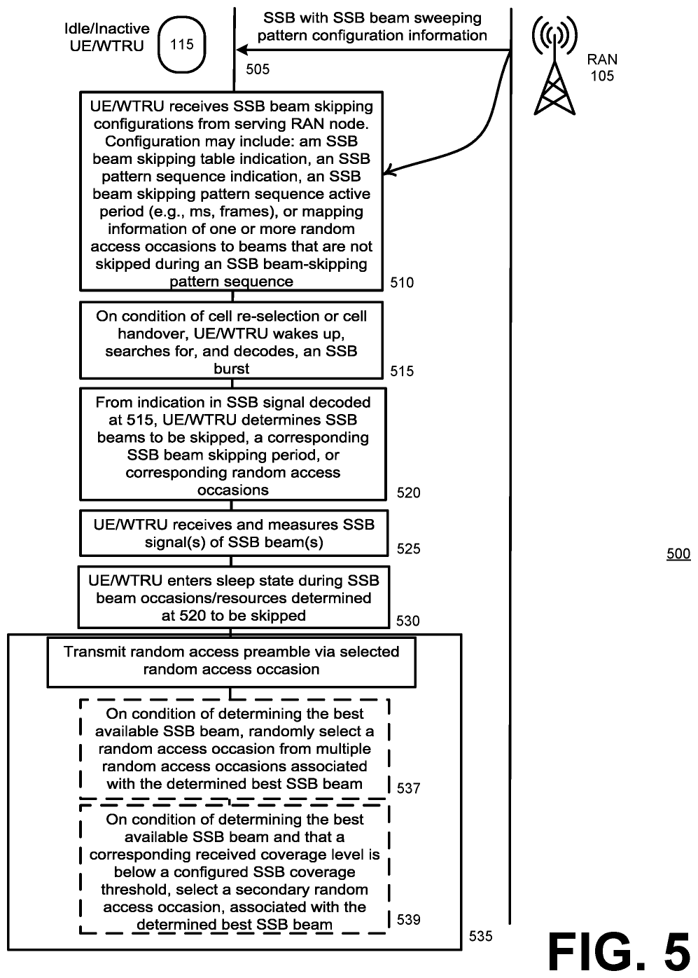

Turning now to FIG. 5, the figure illustrates a timing diagram of an example method 500. RAN 105 may transmit and UE 115 may receive therefrom at act 510, a beam skipping configuration, such as configuration 1200 described in reference to FIG. 12. The configuration transmitted at act 505 may comprise information elements, such as, for example, a beam skipping configuration identifier; one or more beam skipping sequence indexes; beams to be skipped according to a corresponding beam skipping sequence index when transmitting SSB signals by RAN 105; beam skipping sequence active periods (e.g., in terms of milliseconds or frames) corresponding respectively to the one or more beam skipping sequence; or information of one or more random access occasions corresponding to the non-skipped beams during active beam skipping sequences. At act 510, UE 115 may receive a beam skipping sequence indication, such as beam skipping indication 320 described in reference to FIG. 3. Continuing with description of FIG. 5, the beam skipping sequence indication may be transmitted by RAN 105 along with the configuration transmitted at act 505, or via separate signaling, such as an SSB signal, after the configuration was transmitted at act 505. UE 115 may enter an idle mode. On condition of RAN node/cell selection/re-selection or RAN node/cell handover, the UE may exit the sleep mode, or sleep state, at act 515, and search for and decode an SSB burst transmitted by RAN 105. At act 520, UE/WTRU 115 may determine SSB beams to be skipped by RAN in transmitting SSB signaling based on the beam skipping sequence indication received at act 510. At act 525, UE/WTRU 115 may receive signals, and measure signal strengths corresponding thereto, transmitted via beams by RAN 105. In an embodiment, at act 530 UE/WTRU 115 may enter a sleep state during periods corresponding to beams being skipped according to the beam skipping sequence indication received at act 520. It will be appreciated that in an embodiment RAN 105 may transmit SSB signaling via a given beam according to a beam periodicity when the given beam is used to transmit SSB signaling during a beam skipping sequence and the RAN may not transmit SSB signaling during a period that would otherwise be used to transmit SSB signaling if the given beam were not being skipped according to a different beam skipping sequence.

At act 535, on condition of determining a best available SSB beam based on measurements made at act 525, UE 115 may transmit a random-access code, which may be a random-access preamble, using random access occasion resources (e.g., time and frequency resources) corresponding to the beam that the UE determined to be a best beam of non-skipped beams that RAN 115 used to transmit SSB signaling. The transmitting of a random-access code at act 535 may comprise UE 115 determining to transmit a random access code via a primary random access occasion resource corresponding to the determined best beam at act 537 if a signal strength of the determined best beam exceeds a configured signal strength threshold. Alternatively, if UE 115 determines that a signal strength corresponding to a determined best beam does not satisfy a coverage criterion or signal strength criterion, such as, for example a threshold, the UE may transmit at act 539 random access code via a secondary random access occasion resource corresponding to the determined best beam to indicate to RAN 105 that a signal energy pattern of a skipped beam that is geospatially adjacent to, or close to, a signal energy pattern of the beam determined by UE 115 at act 525 to be a best beam may be a better beam for the user equipment than the non-skipped beam that the UE determined to be the best beam. It will be appreciated that act 537 and act 539 may represent options of transmitting of random-access codes at act 535 and thus are shown outlined with dashed lines inside of the block that represents act 535 in FIG. 5 to indicate different possible implementations of act 535.

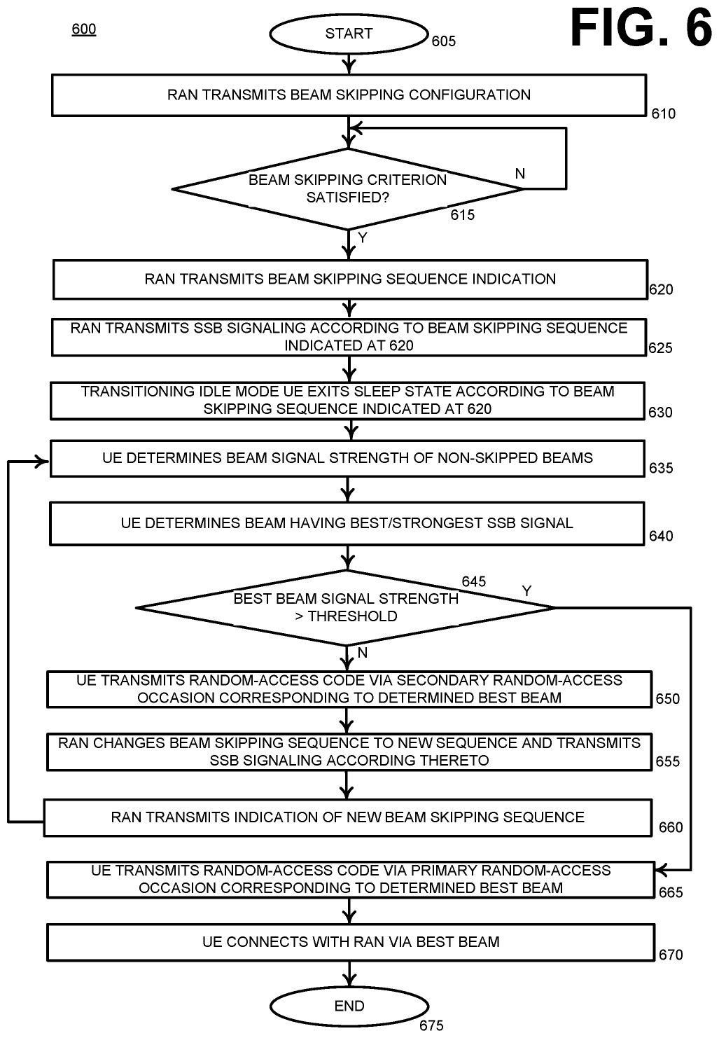

Turning now to FIG. 6, the figure illustrates a flow diagram of an example method 600. Method 600 begins at act 605. At act 610, a radio access network node transmits a beam skipping configuration. The beam skipping configuration may be transmitted via synchronization signal block signaling or other signaling. At act 615, the RAN may determine whether a beam skipping criterion has been satisfied. For example, if a number of user equipment, of any, that are attempting to connect with the RAN in one or more regions that are served by one or more corresponding downlink beams is fewer than a configured threshold, the RAN may determine that the beam skipping criterion has been satisfied. If the beam skipping criterion has not been satisfied, for example the RAN is serving a large number of user equipment attempting to connect with the RAN in a somewhat uniform manner around the RAN (e.g., a number of user equipment attempting to connect with the RAN during a configured period is above a threshold), method 600 may return to act 615.

If, however, the RAN determines at act 615 that the beam skipping criterion has been satisfied, method 600 may advance to act 620. At act 620, the RAN may transmit a beam skipping sequence indication. The beam skipping sequence indication may be transmitted via SSB signaling, or other signaling. The beam skipping sequence indication may be transmitted via an SSB signal before the RAN implements a beam skipping sequence according to the beam skipping sequence indication. In an embodiment, the RAN may transmit the beam skipping sequence indication via an SSB signal that is transmitted according to a beam skipping sequence that corresponds to the beam skipping sequence indication transmitted at act 620.

At act 625, the RAN transmits SSB signaling according to a beam skipping sequence indicated by the beam skipping sequence indication transmitted at act 620. At act 630, a transitioning idle mode user equipment device may exit a sleep state according to the beam skipping sequence indicated at act 620. A transitioning user equipment may be a user equipment that has already camped on the RAN, has determined to connect with the RAN, and has begun the process of connecting to, and accessing, the RAN by searching for and decoding SSB signals transmitted by the RAN.

At act 635, the transitioning idle mode user equipment determines a beam signal strength, or beam signal strengths, of one or more non-skipped beams via which the RAN may have used to transmit SSB signals. At act 640, the transitioning user equipment determines a beam of the non-skipped beams that has a best, or strongest, signal strength based on measuring signal strengths of SSB signals transmitted by the RAN via non skipped beams indicated by the beam skipping sequence transmitted at act 620.

At act 645, the user equipment determines whether the determined best beam has a corresponding signal strength that satisfies a criterion, for example a signal strength threshold. If a determination is made at act 645 that a signal strength of the determined best beam does not satisfy the criterion, for example, a signal strength does not exceed a configured threshold, method 600 advances to act 650. At act 650, the user equipment may transmit a random-access code via a secondary random-access occasion, or resource, corresponding to the determined best beam. The secondary random-access occasion resource that the user equipment uses to transmit the random-access code at act 650 may have been indicated in the configuration received at act 610. In an embodiment, the secondary random-access occasion resources may have been indicated in the beam skipping sequence indication transmitted by the RAN at act 620. At act 655, based on receiving the random-access code via the secondary random-access occasion, the RAN may determine to change the current beam skipping sequence to a new/different beam skipping sequence, and may begin transmitting SSB signaling according to the new/different beam skipping sequence. At act 660, the RAN may transmit an indication, for example an indication 320 described in reference to FIG. 3, of the new/different beam skipping sequence such that the transitioning idle mode user equipment may receive the indication and look up information corresponding to the new/different beam skipping sequence in the configuration transmitted at act 610. Continuing with description of FIG. 6, the user equipment may attempt to detect SSB, at act 635 as described above, SSB signaling according to the new/different beam skipping sequence indicated by the RAN at act 660.

Returning to description of act 645, if a determination is made at act 645 that the beam determined by the user equipment at act 640 to be the best beam has a corresponding signal strength that satisfies a signal strength threshold, the user equipment may transmit at act 665 a random-access code via a primary random-access occasion corresponding to the determined best beam. Based upon receiving the random-access code via the primary random-access occasion, at act 670 the RAN and the transitioning idle mode user equipment may proceed with connection establishment procedures, and the user equipment and RAN may proceed to communicate via the newly established connection. Method 600 advances to act 675 and ends.

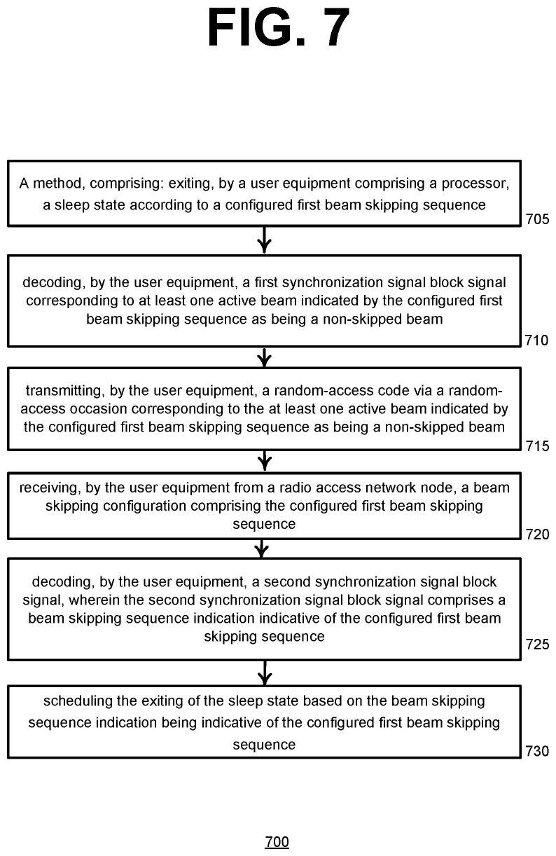

Turning now to FIG. 7, the figure illustrates an example embodiment method 700 comprising at block 705 exiting, by a user equipment comprising a processor, a sleep state according to a configured first beam skipping sequence; at block 710 decoding, by the user equipment, a first synchronization signal block signal corresponding to at least one active beam indicated by the configured first beam skipping sequence as being a non-skipped beam; at block 715 transmitting, by the user equipment, a random-access code via a random-access occasion corresponding to the at least one active beam indicated by the configured first beam skipping sequence as being a non-skipped beam; at block 720 receiving, by the user equipment from a radio access network node, a beam skipping configuration comprising the configured first beam skipping sequence; at block 725 decoding, by the user equipment, a second synchronization signal block signal, wherein the second synchronization signal block signal comprises a beam skipping sequence indication indicative of the configured first beam skipping sequence; and at block 730 scheduling the exiting of the sleep state based on the beam skipping sequence indication being indicative of the configured first beam skipping sequence.

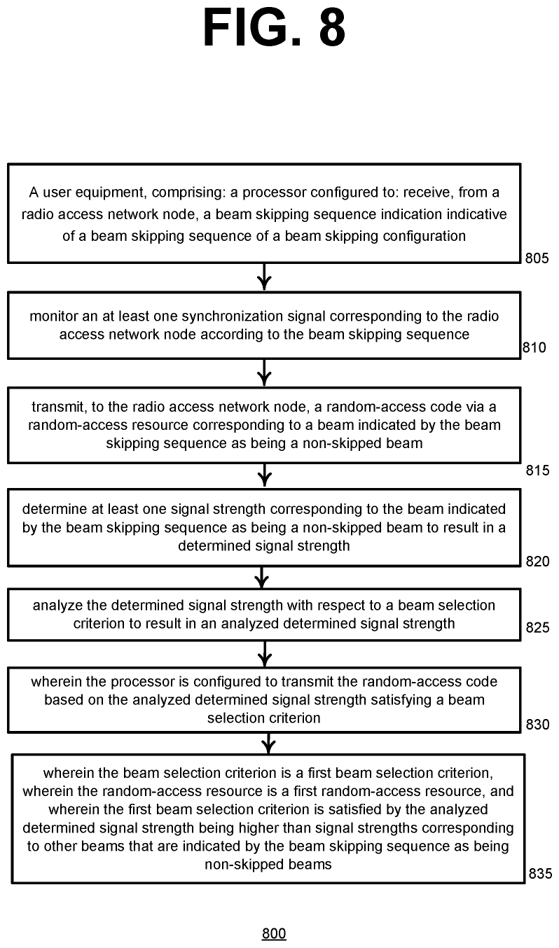

Turning now to FIG. 8, the figure illustrates an example user equipment, comprising at block 805 a processor configured to receive, from a radio access network node, a beam skipping sequence indication indicative of a beam skipping sequence of a beam skipping configuration; at block 810 monitor an at least one synchronization signal corresponding to the radio access network node according to the beam skipping sequence; at block 815 transmit, to the radio access network node, a random-access code via a random-access resource corresponding to a beam indicated by the beam skipping sequence as being a non-skipped beam; at block 820 determine at least one signal strength corresponding to the beam indicated by the beam skipping sequence as being a non-skipped beam to result in a determined signal strength; at block 825 analyze the determined signal strength with respect to a beam selection criterion to result in an analyzed determined signal strength; at block 830 wherein the processor is configured to transmit the random-access code based on the analyzed determined signal strength satisfying a beam selection criterion; and at block 835 wherein the beam selection criterion is a first beam selection criterion, wherein the random-access resource is a first random-access resource, and wherein the first beam selection criterion is satisfied by the analyzed determined signal strength being higher than signal strengths corresponding to other beams that are indicated by the beam skipping sequence as being non-skipped beams.

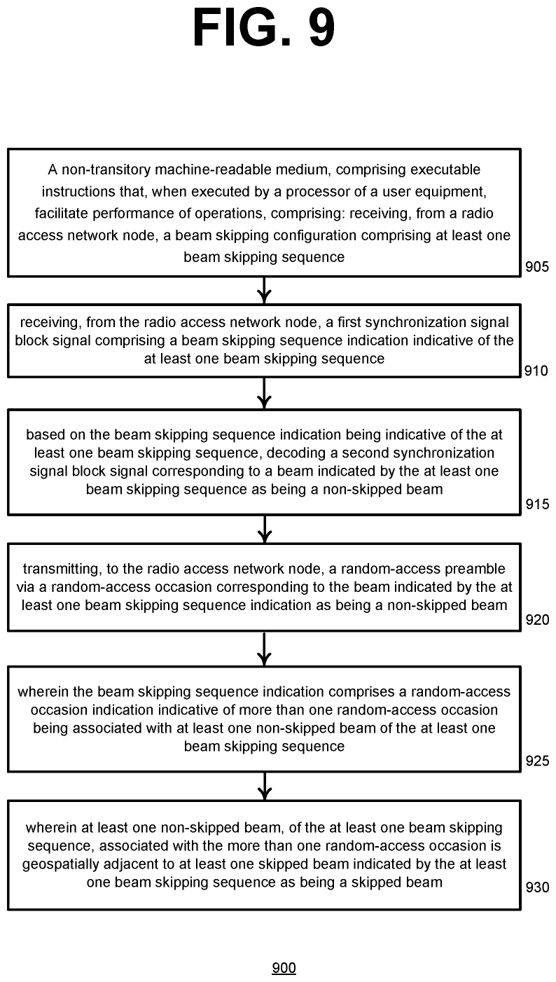

Turning now to FIG. 9, the figure illustrates a non-transitory machine-readable medium 900 comprising at block 905 executable instructions that, when executed by a processor of a user equipment, facilitate performance of operations, comprising receiving, from a radio access network node, a beam skipping configuration comprising at least one beam skipping sequence; at block 910 receiving, from the radio access network node, a first synchronization signal block signal comprising a beam skipping sequence indication indicative of the at least one beam skipping sequence; at block 915 based on the beam skipping sequence indication being indicative of the at least one beam skipping sequence, decoding a second synchronization signal block signal corresponding to a beam indicated by the at least one beam skipping sequence as being a non-skipped beam; at block 920 transmitting, to the radio access network node, a random-access preamble via a random-access occasion corresponding to the beam indicated by the at least one beam skipping sequence indication as being a non-skipped beam; at block 925 wherein the beam skipping sequence indication comprises a random-access occasion indication indicative of more than one random-access occasion being associated with at least one non-skipped beam of the at least one beam skipping sequence; and at block 930 wherein at least one non-skipped beam, of the at least one beam skipping sequence, associated with the more than one random-access occasion is geospatially adjacent to at least one skipped beam indicated by the at least one beam skipping sequence as being a skipped beam.

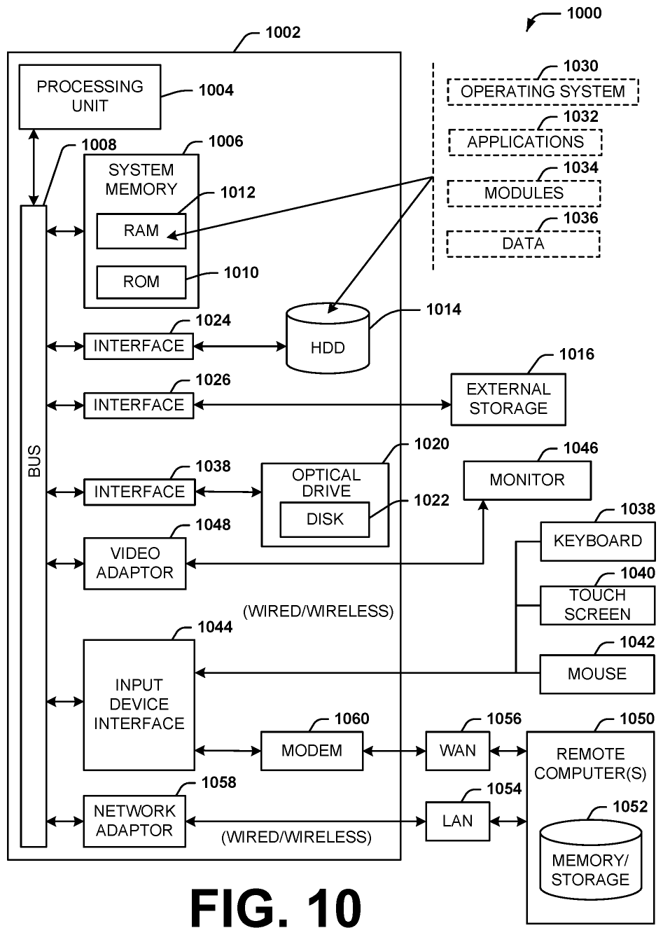

In order to provide additional context for various embodiments described herein, FIG. 10 and the following discussion are intended to provide a brief, general description of a suitable computing environment 1000 in which various embodiments of the embodiment described herein can be implemented. While embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the methods can be practiced with other computer system configurations, including single-processor or multiprocessor computer systems, minicomputers, mainframe computers, IoT devices, distributed computing systems, as well as personal computers, hand-held computing devices, microprocessor-based or programmable consumer electronics, and the like, each of which can be operatively coupled to one or more associated devices.

The embodiments illustrated herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 10, the example environment 1000 for implementing various embodiments described herein includes a computer 1002, the computer 1002 including a processing unit 1004, a system memory 1006 and a system bus 1008. The system bus 1008 couples system components including, but not limited to, the system memory 1006 to the processing unit 1004. The processing unit 1004 can be any of various commercially available processors and may include a cache memory. Dual microprocessors and other multi-processor architectures can also be employed as the processing unit 1004.

The system bus 1008 can be any of several types of bus structure that can further interconnect to a memory bus (with or without a memory controller), a peripheral bus, and a local bus using any of a variety of commercially available bus architectures. The system memory 1006 includes ROM 1010 and RAM 1012. A basic input/output system (BIOS) can be stored in a non-volatile memory such as ROM, erasable programmable read only memory (EPROM), EEPROM, which BIOS contains the basic routines that help to transfer information between elements within the computer 1002, such as during startup. The RAM 1012 can also include a high-speed RAM such as static RAM for caching data.

Computer 1002 further includes an internal hard disk drive (HDD) 1014 (e.g., EIDE, SATA), one or more external storage devices 1016 (e.g., a magnetic floppy disk drive (FDD) 1016, a memory stick or flash drive reader, a memory card reader, etc.) and an optical disk drive 1020 (e.g., which can read or write from a CD-ROM disc, a DVD, a BD, etc.). While the internal HDD 1014 is illustrated as located within the computer 1002, the internal HDD 1014 can also be configured for external use in a suitable chassis (not shown). Additionally, while not shown in environment 1000, a solid-state drive (SSD) could be used in addition to, or in place of, an HDD 1010. The HDD 1014, external storage device(s) 1016 and optical disk drive 1020 can be connected to the system bus 1008 by an HDD interface 1024, an external storage interface 1026 and an optical drive interface 1028, respectively. The interface 1024 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1002, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. The systems and methods described herein can be implemented utilizing various commercially available operating systems or combinations of operating systems.

Computer 1002 can optionally comprise emulation technologies. For example, a hypervisor (not shown) or other intermediary can emulate a hardware environment for operating system 1030, and the emulated hardware can optionally be different from the hardware illustrated in FIG. 10. In such an embodiment, operating system 1030 can comprise one virtual machine (VM) of multiple VMs hosted at computer 1002. Furthermore, operating system 1030 can provide runtime environments, such as the Java runtime environment or the .NET framework, for applications 1032. Runtime environments are consistent execution environments that allow applications 1032 to run on any operating system that includes the runtime environment. Similarly, operating system 1030 can support containers, and applications 1032 can be in the form of containers, which are lightweight, standalone, executable packages of software that include, e.g., code, runtime, system tools, system libraries and settings for an application.

Further, computer 1002 can comprise a security module, such as a trusted processing module (TPM). For instance, with a TPM, boot components hash next in time boot components, and wait for a match of results to secured values, before loading a next boot component. This process can take place at any layer in the code execution stack of computer 1002, e.g., applied at the application execution level or at the operating system (OS) kernel level, thereby enabling security at any level of code execution.

A user can enter commands and information into the computer 1002 through one or more wired/wireless input devices, e.g., a keyboard 1038, a touch screen 1040, and a pointing device, such as a mouse 1042. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1004 through an input device interface 1044 that can be coupled to the system bus 1008, but can be connected by other interfaces, such as a parallel port, an IEEE 1394 serial port, a game port, a USB port, an IR interface, a BLUETOOTH® interface, etc.

A monitor 1046 or other type of display device can be also connected to the system bus 1008 via an interface, such as a video adapter 1048. In addition to the monitor 1046, a computer typically includes other peripheral output devices (not shown), such as speakers, printers, etc.

The computer 1002 can operate in a networked environment using logical connections via wired and/or wireless communications to one or more remote computers, such as a remote computer(s) 1050. The remote computer(s) 1050 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1052 is illustrated. The logical connections depicted include wired/wireless connectivity to a local area network (LAN) 1054 and/or larger networks, e.g., a wide area network (WAN) 1056. Such LAN and WAN networking environments are commonplace in offices and companies, and facilitate enterprise-wide computer networks, such as intranets, all of which can connect to a global communications network, e.g., the internet.

When used in a LAN networking environment, the computer 1002 can be connected to the local network 1054 through a wired and/or wireless communication network interface or adapter 1058. The adapter 1058 can facilitate wired or wireless communication to the LAN 1054, which can also include a wireless access point (AP) disposed thereon for communicating with the adapter 1058 in a wireless mode.

When used in a WAN networking environment, the computer 1002 can include a modem 1060 or can be connected to a communications server on the WAN 1056 via other means for establishing communications over the WAN 1056, such as by way of the internet. The modem 1060, which can be internal or external and a wired or wireless device, can be connected to the system bus 1008 via the input device interface 1044. In a networked environment, program modules depicted relative to the computer 1002 or portions thereof, can be stored in the remote memory/storage device 1052. It will be appreciated that the network connections shown are example and other means of establishing a communications link between the computers can be used.

When used in either a LAN or WAN networking environment, the computer 1002 can access cloud storage systems or other network-based storage systems in addition to, or in place of, external storage devices 1016 as described above. Generally, a connection between the computer 1002 and a cloud storage system can be established over a LAN 1054 or WAN 1056 e.g., by the adapter 1058 or modem 1060, respectively. Upon connecting the computer 1002 to an associated cloud storage system, the external storage interface 1026 can, with the aid of the adapter 1058 and/or modem 1060, manage storage provided by the cloud storage system as it would other types of external storage. For instance, the external storage interface 1026 can be configured to provide access to cloud storage sources as if those sources were physically connected to the computer 1002.

The computer 1002 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

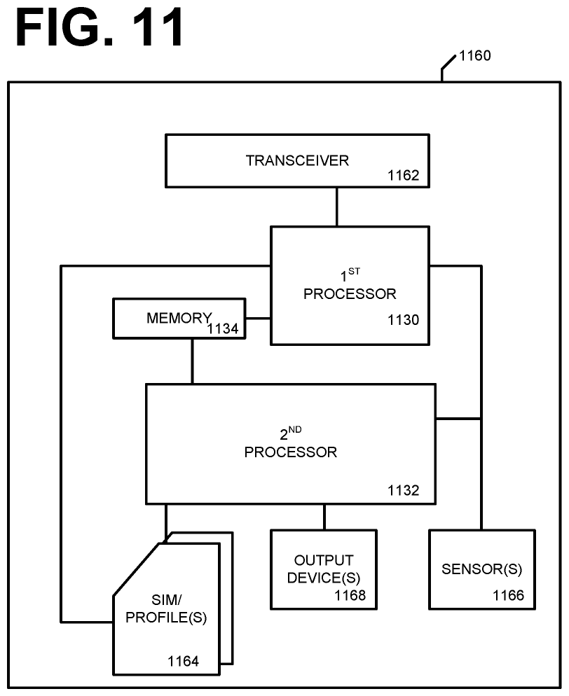

Turning now to FIG. 11, the figure illustrates a block diagram of an example UE 1160. UE 1160 may comprise a smart phone, a wireless tablet, a laptop computer with wireless capability, a wearable device, a machine device that may facilitate vehicle telematics, and the like. UE 1160 comprises a first processor 1130, a second processor 1132, and a shared memory 1134. UE 1160 includes radio front end circuitry 1162, which may be referred to herein as a transceiver, but is understood to typically include transceiver circuitry, separate filters, and separate antennas for facilitating transmission and receiving of signals over a wireless link, such as one or more wireless links 125, 135, or 137 shown in FIG. 1. Furthermore, transceiver 1162 may comprise multiple sets of circuitry or may be tunable to accommodate different frequency ranges, different modulations schemes, or different communication protocols, to facilitate long-range wireless links such as links, device-to-device links, such as links 135, and short-range wireless links, such as links 137.

Continuing with description of FIG. 11, UE 1160 may also include a SIM 1164, or a SIM profile, which may comprise information stored in a memory (memory 34 or a separate memory portion), for facilitating wireless communication with RAN 105 or core network 130 shown in FIG. 1. FIG. 11 shows SIM 1164 as a single component in the shape of a conventional SIM card, but it will be appreciated that SIM 1164 may represent multiple SIM cards, multiple SIM profiles, or multiple eSIMs, some or all of which may be implemented in hardware or software. It will be appreciated that a SIM profile may comprise information such as security credentials (e.g., encryption keys, values that may be used to generate encryption keys, or shared values that are shared between SIM 1164 and another device, which may be a component of RAN 105 or core network 130 shown in FIG. 1). A SIM profile 1164 may also comprise identifying information that is unique to the SIM, or SIM profile, such as, for example, an International Mobile Subscriber Identity (“IMSI”) or information that may make up an IMSI.

SIM 1164 is shown coupled to both the first processor portion 1130 and the second processor portion 1132. Such an implementation may provide an advantage that first processor portion 30 may not need to request or receive information or data from SIM 1164 that second processor 1132 may request, thus eliminating the use of the first processor acting as a ‘go-between’ when the second processor uses information from the SIM in performing its functions and in executing applications. First processor 1130, which may be a modem processor or baseband processor, is shown smaller than processor 1132, which may be a more sophisticated application processor, to visually indicate the relative levels of sophistication (i.e., processing capability and performance) and corresponding relative levels of operating power consumption levels between the two processor portions. Keeping the second processor portion 1132 asleep/inactive/in a low power state when UE 1160 does not need it for executing applications and processing data related to an application provides an advantage of reducing power consumption when the UE only needs to use the first processor portion 1130 while in listening mode for monitoring routine configured bearer management and mobility management/maintenance procedures, or for monitoring search spaces that the UE has been configured to monitor while the second processor portion remains inactive/asleep.

UE 1160 may also include sensors 1166, such as, for example, temperature sensors, accelerometers, gyroscopes, barometers, moisture sensors, and the like that may provide signals to the first processor 1130 or second processor 1132. Output devices 1168 may comprise, for example, one or more visual displays (e.g., computer monitors, VR appliances, and the like), acoustic transducers, such as speakers or microphones, vibration components, and the like. Output devices 1168 may comprise software that interfaces with output devices, for example, visual displays, speakers, microphones, touch sensation devices, smell or taste devices, and the like, that are external to UE 1160.

The following glossary of terms given in Table 1 may apply to one or more descriptions of embodiments disclosed herein.

TABLE 1

| Term | Definition |
|---|---|
| UE | User equipment |
| WTRU | Wireless transmit receive unit |
| RAN | Radio access network |
| QoS | Quality of service |
| DRX | Discontinuous reception |
| EPI | Early paging indication |
| DCI | Downlink control information |
| SSB | Synchronization signal block |
| RS | Reference signal |
| PDCCH | Physical downlink control channel |
| PDSCH | Physical downlink shared channel |
| MUSIM | Multi-SIM UE |
| SIB | System information block |
| MIB | Master information block |
| eMBB | Enhanced mobile broadband |
| URLLC | Ultra reliable and low latency communications |
| mMTC | Massive machine type communications |
| XR | Anything-reality |
| VR | Virtual reality |
| AR | Augmented reality |
| MR | Mixed reality |
| DCI | Downlink control information |
| DMRS | Demodulation reference signals |
| QPSK | Quadrature Phase Shift Keying |
| WUS | Wake up signal |
| HARQ | Hybrid automatic repeat request |
| RRC | Radio resource control |
| C-RNTI | Connected mode radio network temporary identifier |
| CRC | Cyclic redundancy check |
| MIMO | Multi input multi output |
| UE | User equipment |
| CBR | Channel busy ratio |
| SCI | Sidelink control information |
| SBFD | Sub-band full duplex |
| CLI | Cross link interference |
| TDD | Time division duplexing |
| FDD | Frequency division duplexing |
| BS | Base-station |
| RS | Reference signal |
| CSI-RS | Channel state information reference signal |
| PTRS | Phase tracking reference signal |
| DMRS | Demodulation reference signal |
| BS | Base-station |
| gNB | General NodeB |
| PUCCH | Physical uplink control channel |
| PUSCH | Physical uplink shared channel |
| SRS | Sounding reference signal |
| NES | Network energy saving |
| QCI | Quality class indication |
| RSRP | Reference signal received power |
| PCI | Primary cell ID |

The above description includes non-limiting examples of the various embodiments. It is, of course, not possible to describe every conceivable combination of components or methodologies for purposes of describing the disclosed subject matter, and one skilled in the art may recognize that further combinations and permutations of the various embodiments are possible. The disclosed subject matter is intended to embrace all such alterations, modifications, and variations that fall within the spirit and scope of the appended claims.

With regard to the various functions performed by the above-described components, devices, circuits, systems, etc., the terms (including a reference to a “means”) used to describe such components are intended to also include, unless otherwise indicated, any structure(s) which performs the specified function of the described component (e.g., a functional equivalent), even if not structurally equivalent to the disclosed structure. In addition, while a particular feature of the disclosed subject matter may have been disclosed with respect to only one of several implementations, such feature may be combined with one or more other features of the other implementations as may be desired and advantageous for any given or particular application.

The terms “exemplary” and/or “demonstrative” or variations thereof as may be used herein are intended to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

The term “or” as used herein is intended to mean an inclusive “or” rather than an exclusive “or.” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The term “set” as employed herein excludes the empty set, i.e., the set with no elements therein. Thus, a “set” in the subject disclosure includes one or more elements or entities. Likewise, the term “group” as utilized herein refers to a collection of one or more entities.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

The description of illustrated embodiments of the subject disclosure as provided herein, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A method, comprising:
exiting, by a user equipment comprising a processor, a sleep state according to a configured first beam skipping sequence;
decoding, by the user equipment, a first synchronization signal block signal corresponding to at least one active beam indicated by the configured first beam skipping sequence as being a non-skipped beam; and
transmitting, by the user equipment, a random-access code via a random-access occasion corresponding to the at least one active beam indicated by the configured first beam skipping sequence as being a non-skipped beam.

2. The method of claim 1, further comprising:
entering the sleep state according to the configured first beam skipping sequence.

3. The method of claim 1, further comprising:
decoding, by the user equipment, a second synchronization signal block signal,
wherein the second synchronization signal block signal comprises a beam skipping sequence indication indicative of the configured first beam skipping sequence.

4. The method of claim 3, wherein the beam skipping sequence indication comprises an active time indication indicative of an active period of the configured first beam skipping sequence.

5. The method of claim 3, wherein the beam skipping sequence indication comprises a random-access occasion indication indicative of more than one random-access occasion being associated by the configured first beam skipping sequence with at least one non-skipped beam.

6. The method of claim 5, wherein at least one non-skipped beam associated with the more than one random-access occasion is geospatially adjacent to at least one skipped beam indicated by the configured first beam skipping sequence as being a skipped beam.

7. The method of claim 1, further comprising:
receiving, by the user equipment from a radio access network node, a beam skipping configuration comprising the configured first beam skipping sequence.

8. The method of claim 1, further comprising:
receiving, by the user equipment from a radio access network node, a beam skipping configuration comprising the configured first beam skipping sequence;
decoding, by the user equipment, a second synchronization signal block signal, wherein the second synchronization signal block signal comprises a beam skipping sequence indication indicative of the configured first beam skipping sequence; and
scheduling the exiting of the sleep state based on the beam skipping sequence indication being indicative of the configured first beam skipping sequence.

9. The method of claim 1, further comprising:
determining, by the user equipment, at least one signal strength corresponding to the at least one active beam indicated by the configured first beam skipping sequence as being a non-skipped beam to result in a determined at least one signal strength; and
analyzing, by the user equipment, the determined at least one signal strength with respect to a beam selection criterion to result in an analyzed determined signal strength,
wherein the transmitting of the random-access code is based on the analyzed determined signal strength satisfying a beam selection criterion.

10. The method of claim 9, wherein the beam selection criterion is a first beam selection criterion, wherein the random-access occasion is a first random-access occasion, and wherein the first beam selection criterion is satisfied by the analyzed determined signal strength being higher than signal strengths corresponding to other of the at least one active beam indicated by the configured first beam skipping sequence as being a non-skipped beam.

11. The method of claim 9, wherein the beam selection criterion is a second beam selection criterion, wherein the random-access occasion is a second random-access occasion, and wherein the second beam selection criterion is satisfied by the analyzed determined signal strength being lower than a configured signal strength threshold.

12. The method of claim 11, wherein the at least one active beam is geospatially adjacent to at least one skipped beam indicated by the configured first beam skipping sequence as being a skipped beam, and wherein the transmitting of the random-access code via the second random-access occasion is to be indicative to a radio access network node to select a configured second beam skipping sequence that does not indicate as a skipped beam the at least one skipped beam that is geospatially adjacent to the at least one active beam.

13. A user equipment, comprising:
a processor configured to:
receive, from a radio access network node, a beam skipping sequence indication indicative of a beam skipping sequence of a beam skipping configuration;
monitor an at least one synchronization signal corresponding to the radio access network node according to the beam skipping sequence; and
transmit, to the radio access network node, a random-access code via a random-access resource corresponding to a beam indicated by the beam skipping sequence as being a non-skipped beam.

14. The user equipment of claim 13, wherein the at least one synchronization signal comprises a random-access transmission indication indicative of more than one random-access resource being associated with at least one non-skipped beam corresponding to the beam skipping sequence.

15. The user equipment of claim 13, wherein the processor is further configured to:
determine at least one signal strength corresponding to the beam indicated by the beam skipping sequence as being a non-skipped beam to result in a determined signal strength; and
analyze the determined signal strength with respect to a beam selection criterion to result in an analyzed determined signal strength,
wherein the processor is configured to transmit the random-access code based on the analyzed determined signal strength satisfying a beam selection criterion.

16. The user equipment of claim 15, wherein the beam selection criterion is a first beam selection criterion, wherein the random-access resource is a first random-access resource, and wherein the first beam selection criterion is satisfied by the analyzed determined signal strength being higher than signal strengths corresponding to other beams that are indicated by the beam skipping sequence as being non-skipped beams.

17. The user equipment of claim 15, wherein the beam selection criterion is a second beam selection criterion, wherein the random-access resource is a second random-access resource, and wherein the second beam selection criterion is satisfied by the analyzed determined signal strength being higher than signal strengths corresponding to other beams that are indicated by the beam skipping sequence as being non-skipped beams and by the analyzed determined signal strength being lower than a configured signal strength threshold.

18. A non-transitory machine-readable medium, comprising executable instructions that, when executed by a processor of a user equipment, facilitate performance of operations, comprising:
receiving, from a radio access network node, a beam skipping configuration comprising at least one beam skipping sequence;
receiving, from the radio access network node, a first synchronization signal block signal comprising a beam skipping sequence indication indicative of the at least one beam skipping sequence;
based on the beam skipping sequence indication being indicative of the at least one beam skipping sequence, decoding a second synchronization signal block signal corresponding to a beam indicated by the at least one beam skipping sequence as being a non-skipped beam; and
transmitting, to the radio access network node, a random-access preamble via a random-access occasion corresponding to the beam indicated by the at least one beam skipping sequence indication as being a non-skipped beam.

19. The non-transitory machine-readable medium of claim 18, wherein the beam skipping sequence indication comprises a random-access occasion indication indicative of more than one random-access occasion being associated with at least one non-skipped beam of the at least one beam skipping sequence.

20. The non-transitory machine-readable medium of claim 19, wherein at least one non-skipped beam, of the at least one beam skipping sequence, associated with the more than one random-access occasion is geospatially adjacent to at least one skipped beam indicated by the at least one beam skipping sequence as being a skipped beam.
